(19) United States
(12) Patent Application Publication
(10) Pub. No.: US 2003/0141491 A1
(43) Pub. Date: Jul. 31, 2003

(54) Heat-sensitive recording material

(75) Inventors: Masao Sato, Shizuoka-ken (JP); Yohsuke Takeuchi, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/285,443

(22) Filed: Nov. 1, 2002

(30) Foreign Application Priority Data
Nov. 5, 2001 (JP) 2001-339252
Nov. 5, 2001 (JP) 2001-339253

(51) Int. Cl. G02B 5/22

(52) U.S. Cl. 252/588

(57) ABSTRACT

A heat-sensitive recording material including a support having succesively disposed thereon a heat-sensitive recording layer, a light transmittance adjusting layer and a protective layer, wherein the light transmittance adjusting layer contains a UV absorbent precursor represented by the general formula (1):

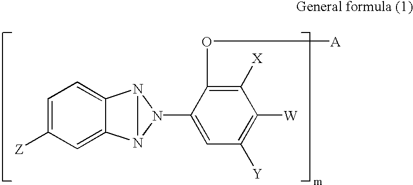

wherein m represents 1 or 2; A represents —SO₂—R, —CO—R, —CO₂—R, —CONH—R, —POR¹R², —CH₂R³ or —SiR⁴R⁵R⁶ when m is 1, or A represents —SO₂R⁷SO₂—, —CO—, —COCO—, —COR⁷CO—, —SO₂— or —SO— when m is 2; W represents a hydrogen atom, an alkyl group, an aryl group or a halogen atom; X and Y each represent a hydrogen atom, an alkyl group, an alkoxy group, aryl group or a halogen atom; and Z represents a halogen atom. The light transmittance adjusting layer may contain at least one precursor to a UV absorbent having a maximum absorption wavelength of 348 nm or more.

### BACKGROUND OF THE INVENTION

1. Field of the Invention

The present invention relates to a heat-sensitive recording material, and more particularly, to a heat-sensitive recording material that is excellent in light fastness.

2. Description of the Related Art

Heat-sensitive recording has been developed in recent years since the apparatus therefor is simple, highly reliable, and maintenance-free. Among conventional heat-sensitive recording materials, ones utilizing a reaction between an electron-donating dye precursor and an electron-accepting compound, ones utilizing a reaction between a diazonium salt compound and a coupler, and the like are widely known. Recently, the heat-sensitive recording materials have been studied extensively to improve characteristics thereof such as color density, sensitivity in terms of developed color density and light fastness of formed color.

Light fastness of heat-sensitive recording materials at background areas has also been investigated extensively, for the following reasons. Since the heat-sensitive recording materials are generally displayed for a long period of time after images have been recorded, it is important to prevent not only color change or fading at image areas, but also coloring (staining due to light exposure) at background areas and the like. Various methods have been proposed to prevent occurrence of light staining, but under current circumstances sufficient effects cannot always be obtained.

The inventors of the present invention have conducted extensive research to solve the above-described problems and found that light staining in particular can be suppressed at background areas when a UV absorbent precursor having a specific structure and having a maximum absorption wavelength of 348 nm or more is used.

However, the UV absorbent precursor having a maximum absorption wavelength of 348 nm or more has problems in that it is low in solubility and is likely to be separated out (deposited) when a coating solution is prepared therefrom.

### SUMMARY OF THE INVENTION

The present invention has been developed in view of the above-described problems. That is, an object of the invention is to provide a heat-sensitive recording material in which a layer containing a UV absorbent precursor can be readily and stably formed and by which light staining at background areas can be sufficiently prevented.

A first aspect of the invention is a heat-sensitive recording material comprising a support having succesively disposed thereon a heat-sensitive recording layer, a light transmittance adjusting layer and a protective layer, wherein the light transmittance adjusting layer contains a UV absorbent precursor represented by the following general formula (1)

General Formula (1)

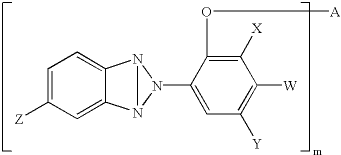

wherein:

m represents 1 or 2; A represents —SO₂—R, —CO—R, —CO₂—R, —CONH—R, —POR¹R², —CH₂R³ or —SiR⁴R⁵R⁶ when m is 1, and A represents —SO₂R⁷SO₂—, —CO—, —COCO—, —COR⁷CO—, —SO₂— or —SO— when m is 2, in which R represents an alkyl group or an aryl group; R¹ and R² each represent an alkoxy group, an aryloxy group, an alkyl group or an aryl group; R³ represents a phenyl group substituted with at least one nitro group or at least one methoxy group; R⁴, R¹ and R⁶ each represent an alkyl group or an aryl group; and R⁷ represents an alkylene group or an arylene group; W represents a hydrogen atom, an alkyl group, an aryl group or a halogen atom; X and Y each represent a hydrogen atom, an alkyl group, an alkoxy group, an aryl group or a halogen atom; and Z represents a halogen atom.

The heat-sensitive recording material according to the first aspect of the invention, characterized by containing the UV absorbent precursor represented by the general formula (1) (wherein Z represents a halogen atom), can sufficiently suppress occurrence of light staining at background areas. It is preferable that a UV absorbent, converted from the UV absorbent precursor represented by the general formula (1), has a maximum absorption wavelength of 348 nm or more. Effects of the invention can be efficiently exerted when the UV absorbent has a maximum absorption wavelength of 348 nm or more.

A second aspect of the invention is a heat-sensitive recording material comprising a support having succesively disposed thereon at least a heat-sensitive recording layer, a light transmittance adjusting layer and a protective layer, wherein the light transmittance adjusting layer contains two or more kinds of UV absorbent precursors represented by the following general formula (1), and a UV absorbent converted from at least one of the UV absorbent precursors has a maximum absorption wavelength of 348 nm or more

General Formula (1)

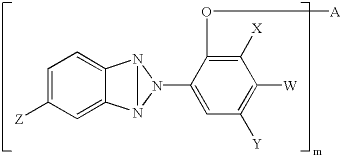

wherein

m represents 1 or 2; A represents —SO₂—R, —CO—R, —CO₂—R, —CONH—R, —POR¹R², —CH₂R³ or —SiR⁴R⁵R⁶ when m is 1, and A represents —SO₂R⁷SO₂—, —CO—, —COCO—, —COR⁷CO—, —SO₂— or —SO— when m is 2, in which R represents an alkyl group or an aryl group; R¹ and R² each represent an alkoxy group, an aryloxy group, an alkyl group or an aryl group; R³ represents a phenyl group substituted with at least one nitro group or at least one methoxy group; R⁴, R⁵ and R⁶ each represent an alkyl group or an aryl group; and R⁷ represents an alkylene group or an arylene group; W represents a hydrogen atom, an alkyl group, an aryl group or a halogen atom; X and Y each represent a hydrogen atom, an alkyl group, an alkoxy group, an aryl group or a halogen atom; and Z represents a hydrogen atom, a halogen atom, an alkyl group or an alkoxy group.

It is essential that the heat-sensitive recording material according to the second aspect of the invention contains two or more kinds of the UV absorbent precursors. The recording material preferably contains three or more kinds of the precursors, and more preferably four or more kinds of the precursors.

The heat-sensitive recording material according to the second aspect of the invention, characterized by containing the UV absorbent precursor that is represented by the general formula (1) and convertible to the UV absorbent having a maximum absorption wavelength of 348 nm or more, can sufficiently suppress occurrence of light staining at background areas. Furthermore, due to inclusion of the UV absorbent precursor that is represented by the general formula (1) and convertible to the UV absorbent having a maximum absorption wavelength of less than 348 nm, the heat-sensitive recording material can exhibit enhanced solubility and may readily and stably be formulated into a coating solution for forming a layer.

In the heat-sensitive recording material according to the second aspect of the invention, it is preferable that the light transmittance adjusting layer contains the UV absorbent precursor represented by the general formula (1) and convertible to the UV absorbent having a maximum absorption wavelength of 348 nm or more, in an amount of 25% by mass or more, relative to a total mass of the UV absorbent precursors, in order to exert enhanced light fastness at background areas. Further, taking the solubility of the precursor in a coating solution for forming the layer into consideration, it is preferable that the light transmittance adjusting layer contains the UV absorbent precursor represented by the general formula (1) and convertible to the UV absorbent having a maximum absorption wavelength of 348 nm or more, in an amount of from 25 to 99% by mass, more preferably from 45 to 95% by mass, and still more preferably from 65 to 90% by mass, relative to the total mass of the UV absorbent precursors.

### DETAILED DESCRIPTION OF THE PREFERRED EMBODIMENTS

Preferred embodiments of the present invention will now be described by successively referring to a light transmittance adjusting layer, a heat-sensitive recording layer, a support and a protective layer. The heat-sensitive recording material may further have an intermediate layer and an undercoat layer, in addition to the above-mentioned layers.

Since the UV absorbent precursor represented by the general formula (1) is contained not in the protective layer, which is the outermost layer, but in the light transmittance adjusting layer, the UV absorbent precursor is not influenced by direct contact with a thermal head. Further, if the UV absorbent precursor is encapsulated in microcapsules, the precursor is prevented from diffusing into other layers, thereby avoiding problems such as lowered sensitivity.

Each of the layers of the heat-sensitive recording material described above may comprise a single layer or multiple layers.

Light Transmittance Adjusting Layer

In the heat-sensitive recording material according to the first aspect of the invention, the light transmittance adjusting layer contains the UV absorbent precursor represented by the general formula (1) shown below.

Since the compound represented by the general formula (1) is a precursor to a UV absorbent, it does not function as the UV absorbent, but when an image is fixed in the heat-sensitive recording layer, the presursor exhibits excellent light transmittance sufficient to transmit light of a specific wavelength region required for image fixation. Thus, if the precursor is included in the light transmittance adjusting layer, it becomes possible to stably conduct image fixation in the heat-sensitive recording layer.

After light irradiation for fixing an image in the heat-sensitive recording layer is completed, the UV absorbent precursor is converted to the UV absorbent by application of light or heat, and thereby starts to function as the UV absorbent. The UV absorbent thus generated absorbs light having a wavelength in the ultraviolet region, whereby the heat-sensitive recording material acquires increased light fastness without a reduction in visible light transmittance, since the generated UV absorbent does not have a function of absorbing visible light.

The UV absorbent precursor represented by the general formula (1) and used in the heat-sensitive recording material according to the first aspect of the invention will be described in detail below.

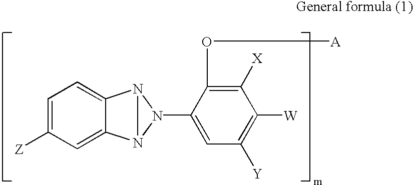

In the general formula (1), m represents 1 or 2.

In the general formal (1), A represents —SO₂—R, —CO—R, —CO₂—R, —CONH—R, —POR¹R², —CH₂R³ or —SiR⁴R⁵R⁶, and preferably —SO₂—R, when m is 1, and represents —SO₂R⁷SO₂—, —CO—, —COCO—, —COR⁷CO—, —SO₂— or —SO— when m is 2.

R represents an alkyl group or an aryl group; R¹and R² each represent an alkoxy group, an aryloxy group, an alkyl group or an aryl group; R³ represents a phenyl group substituted with at least one nitro group or at least one methoxy group; R⁴, R⁵ and R⁶ each represent an alkyl group or an aryl group; and R⁷ represents an alkylene group or an arylene group.

R preferably represents an alkyl group having from 1 to 18 carbon atoms or an aryl group having from 6 to 18 carbon atoms, and more preferably an alkyl group having from 1 to 12 carbon atoms or an aryl group having from 6 to 12 carbon atoms.

R¹ and R² each preferably represent an alkoxy group having from 1 to 12 carbon atoms, an aryloxy group having from 6 to 12 carbon atoms, an alkyl group having from 1 to 12 carbon atoms or an aryl group having from 6 to 12 carbon atoms.

R³ preferably represents a 2-nitrophenyl group, a 3,5-dimethoxyphenyl group or a 3,4,5-trimethoxyphenyl group.

R⁴, R⁵ and R⁶ each preferably represent an alkyl group having from 1 to 12 carbon atoms or an aryl group having from 6 to 12 carbon atoms. Among these, an alkyl group having from 1 to 8 carbon atoms and a phenyl group are particularly preferable.

In a so-called bis compound having two benzotriazole rings in one molecule, R⁷ preferably represents an alkylene group having from 1 to 12 carbon atoms or an arylene group having from 6 to 12 carbon atoms, and R⁸ preferably represents an alkyl group having from 1 to 6 carbon atoms.

In the general formula (1), W represents a hydrogen atom, an alkyl group, an aryl group or a halogen atom; and X and Y each represent a hydrogen atom, an alkyl group, an alkoxy group, an aryl group or a halogen atom. The groups represented by W, X and Y may be the same as or different from each other.

W preferably represents a hydrogen atom, an alkyl group having from 1 to 18 carbon atoms, an aryl group having from 6 to 18 carbon atoms, a fluorine atom, a chlorine atom or a bromine atom, and among these, a hydrogen atom, an alkyl group having from 1 to 12 carbon atoms, a phenyl group and a chlorine atom are particularly preferable.

X and Y each preferably represent a hydrogen atom, an alkyl group having from 1 to 18 carbon atoms, an alkoxy group having from 1 to 18 carbon atoms, an aryl group having from 6 to 18 carbon atoms, a fluorine atom, a chlorine atom or a bromine atom, and among these, a hydrogen atom, an alkyl group having from 1 to 12 carbon atoms, an alkoxy group having from 1 to 12 carbon atoms, a phenyl group and a chlorine atom are particularly preferable.

In the general formula (1), Z represents a halogen atom, preferably a chlorine atom or a fluorine atom, and particularly preferably a chlorine atom.

The alkyl group may be linear or branched and may have an unsaturated bond. The alkyl groups may be substituted with a substituent, such as an alkoxy group, an aryloxy group, an alkoxycarbonyl group, an aryloxycarbonyl group, an aryl group and a hydroxyl group. The aryl group may be further substituted with an alkyl group, an alkoxy group or a halogen atom.

The alkylene group may be linear or branched and may have an unsaturated bond, an oxygen atom, a sulfur atom and a nitrogen atom. The alkylene groups may be further substituted with an alkoxy group, a hydroxyl group, an aryloxy group or an aryl group.

The arylene group may be substituted with a substituent, such as an alkyl group, an alkoxy group and a halogen atom.

Specific examples of the substituent will be described below, but the invention is not construed as being limited thereto.

Examples of the monovalent substituent represented by A include a methanesulfonyl group, an ethanesulfonyl group, a butanesulfonyl group, a benzenesulfonyl group, a 4-methylbenzenesulfonyl group, a 2-mesitylenesulfonyl group, a 4-methoxybenzenesulfonyl group, a 4-octyloxybenzenesulfonyl group, a 2,4,6-triisopropylbenzenesulfonyl group, a β-styrenesulfonyl group, a vinylbenzenesulfonyl group, a 4-chlorobenzenesulfonyl group, a 2,5-dichlorobenzenesulfonyl group, a 2,4,5-trichlorobenzenesulfonyl group, a 1-naphthalenesulfonyl group, a 2-naphthalenesulfonyl group, a quinolinesulfonyl group, a thiophenesulfonyl group, an acetyl group, a propionyl group, a butyryl group, a pivaloyl group, a lauroyl group, a stearoyl group, a benzoyl group, a cinnamoyl group, a furoyl group, a nicotinoyl group, a methoxycarbonyl group, an ethoxycarbonyl group, a phenoxycarbonyl group, a hexylaminocarbonyl group, a phenylaminocarbonyl group, a diphenylphosphoryl group, a diethylphosphoryl group, a 2-nitrobenzyl group, a 3,5-dimethoxybenzyl group, a 3,4,5-trimethoxybenzyl group, a trimethylsilyl group, a triethylsilyl group, a t-butyldimethylsilyl group, a diethylisopropylsilyl group, a dimethylphenylsilyl group, a diphenylmethylsilyl group and a triphenylsilyl group. Specific examples of the divalent substituent represented by A include the following groups.

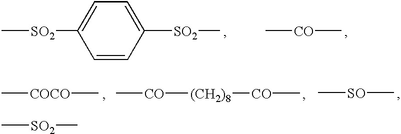

In the case where A represents —SiR⁴R⁵R⁶, a photo-acid generating agent for improving the photo-reactivity, such as an ammonium salt, a diazonium salt, an iodonium salt, a sulfonium salt, a phosphonium salt and an onium salt, may be used in combination. Specific examples of the photo-acid generating agent are described in detail in “Imaging-yo Yuki Zairyo (Organic Materials for Imaging)” edited by The Society of Organic Electronics Materials (1993).

Examples of the monovalent substituent represented by W, X and Y include a hydrogen atom, a methyl group, an ethyl group, an n-propyl group, an isopropyl group, an n-butyl group, an isobutyl group, a sec-butyl group, a t-butyl group, a pentyl group, a hexyl group, an octyl group, a decyl group, a dodecyl group, an allyl group, a 2-butenyl group, a benzyl group, an α-dimethylbenzyl group, a methoxy group, an ethoxy group, a propyloxy group, a butyloxy group, an octyloxy group, a dodecyloxy group, a methoxyethoxy group, a phenoxyethoxy group, a methoxycarbonylethyl group, an ethoxycarbonylethyl group, a propyloxycarbonylethyl group, a butyloxycarbonylethyl group, an octyloxycarbonylethyl group, a phenoxycarbonylethyl group, a phenyl group, a tolyl group, a chlorine atom, a fluorine atom and a bromine atom. Examples of the divalent substituent represented by W, X and Y include the following groups (with a proviso that an alkoxy group for W is excluded from the exemplified substituents).

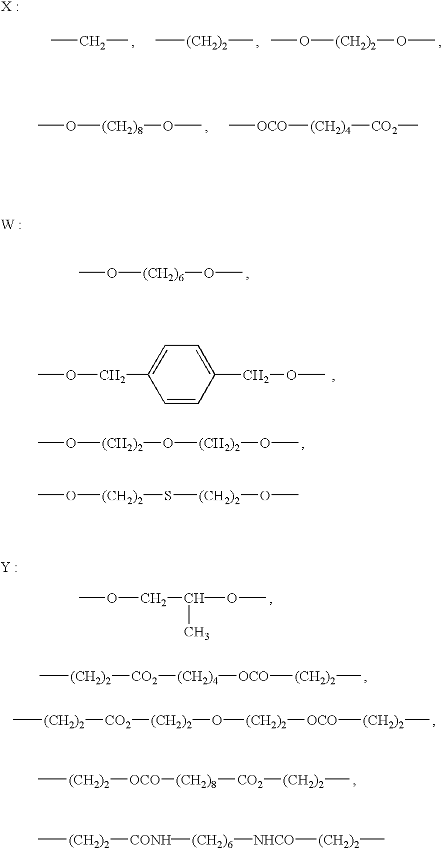

Specific examples of the UV absorbent precursor represented by the general formula (1) used in the heat-sensitive recording material according to the first aspect of the invention will be described below, but the invention is not construed as being limited thereto. These compounds may be used singly or in combination of two or more thereof.

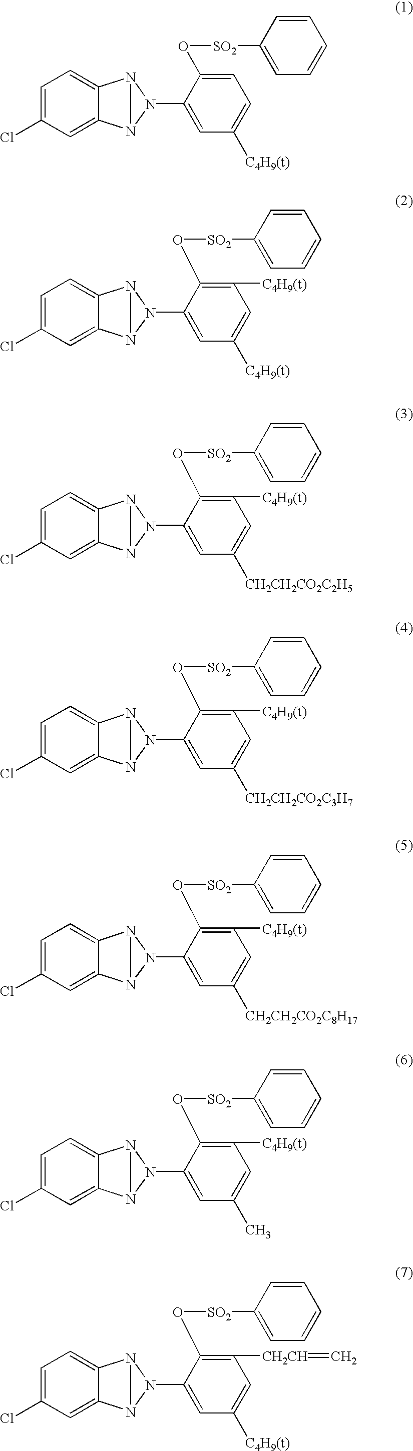

In the heat-sensitive recording material according to the second aspect of the invention, the light transmittance adjusting layer contains two or more kinds of UV absorbent precursors represented by the following general formula (1), at least one kind of which is converted to become a UV absorbent having a maximum absorption wavelength of 348 nm or more.

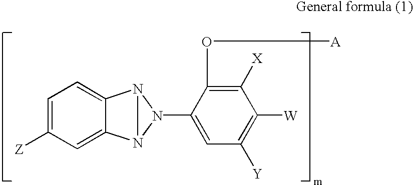

In the formula, m, A, X, Y and W have the same meanings as defined for the UV absorbent precursor represented by the general formula (1) used in the first aspect of the invention; and Z represents a hydrogen atom, a halogen atom, an alkyl group or an alkoxy group.

Z preferably represents a hydrogen atom, a chlorine atom, a fluorine atom, an alkyl group having from 1 to 12 carbon atoms or an alkoxy group having from 1 to 12 carbon atoms, and among these, a hydrogen atom, a chlorine atom, an alkyl group having from 1 to 6 carbon atoms and an alkoxy group having from 1 to 6 carbon atoms are particularly preferable.

Among the UV absorbent precursors convertible to the UV absorbent exhibiting a maximum absorption wavelength of 348 nm or more, the precursors in which Z represents a halogen atom, particularly a chlorine atom are preferable.

Because the compound represented by the general formula (1) is a precursor, it does not function as a UV absorbent, but when an image is formed in the heat-sensitive recording layer, the precursor exhibits high light transmittance sufficient to transmit light having a specific wavelength required for the image fixation. Thus, the image fixation in the heat-sensitive recording layer can be stably carried out.

After light irradiation required for fixing images in the heat-sensitive recording layer is complete, the UV absorbent precursor is converted to the UV absorbent by application of light or heat, thereby starting to act as the UV absorbent. The UV absorbent thus formed absorbs light having a wavelength of ultraviolet region, whereby the heat-sensitive recording material acquires increased light fastness without reducing visible light transmittance, since the formed UV absorbent does not have an effect to absorb visible light.

Specific examples of the UV absorbent precursor represented by the general formula (1) used in the heat-sensitive recording material according to the second aspect of the invention will be described below, but the invention is not construed as being limited thereto.

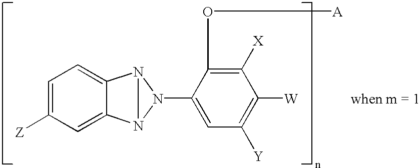

| | A | X | W | V | Z |
|---|---|---|---|---|---|
| (1) | 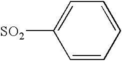 | H | H | CH₃ | H |
| (2) | 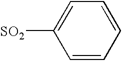 | H | H | C₄H₉(t) | H |
| (3) | 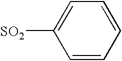 | H | H | C₈H₁₇(t) | H |
| (4) | 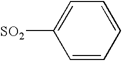 | H | H | C₄H₉(t) | Cl |
| (5) | 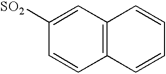 | H | H | C₄H₉(t) | H |
| (6) | 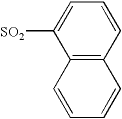 | H | H | C₄H₉(t) | H |
| (7) | 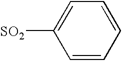 | C₄H₉(sec) | H | C₄H₉(t) | H |
| (8) | 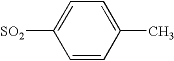 | C₄H₉(sec) | H | C₄H₉(t) | H |
| (9) | 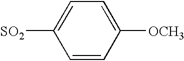 | C₄H₉(sec) | H | C₄H₉(t) | H |
| (10) | 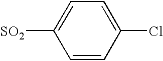 | C₄H₉(sec) | H | C₄H₉(t) | H |
| (11) | 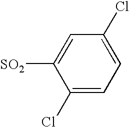 | C₄H₉(sec) | H | C₄H₉(t) | H |
| (12) | 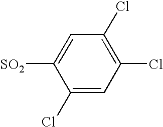 | C₄H₉(sec) | H | C₄H₉(t) | H |
| (13) | 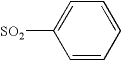 | C₄H₉(t) | H | C₄H₉(t) | H |
| (14) | 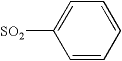 | C₄H₉(t) | H | C₄H₉(t) | Cl |
| (15) | 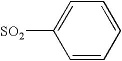 | C₄H₉(t) | H | C₄H₉(t) | CH₃ |
| (16) | 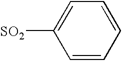 | C₅H₁₁(t) | H | C₅H₁₁(t) | H |
| (17) | 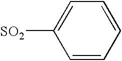 | C₁₂H₂₅ | H | CH₃ | H |
| (18) | 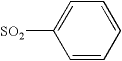 | H | OC₈H₁₇ | H | H |
| (19) | 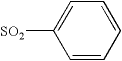 | H | H | OCH₃ | H |
| (20) | 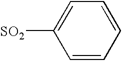 | C₄H₉(t) | H | (CH₂)₂CO₂CH₃ | H |
| (21) | 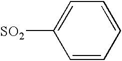 | C₄H₉(t) | H | (CH₂)₂CO₂C₂H₅ | Cl |
| (22) | 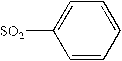 | C₄H₉(t) | H | (CH₂)₂CO₂C₃H₇ | Cl |
| (23) | 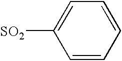 | C₄H₉(t) | H | (CH₂)₂CO₂C₈H₁₇ | Cl |
| (24) | 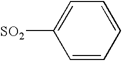 | C₄H₉(t) | H | CH₃ | Cl |
| (25) | 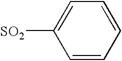 | CH₂CH═CH₂ | H | C₄H₉(t) | H |
| (26) | 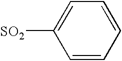 | CH₂CH═CH₂ | H | C₄H₉(t) | Cl |
| (27) | 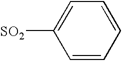 | CH₂CH═CH₂ | H | C₈H₁₇(t) | H |
| (28) | COCH₃ | H | H | C₄H₉(t) | H |
| (29) | 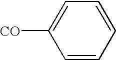 | C₄H₉(t) | H | C₄H₉(t) | Cl |
| (30) | CO₂CH₃ | 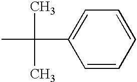 | H | 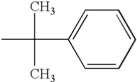 | H |
| (31) | CO₂C₂H₅ | C₄H₉(t) | H | C₄H₉(t) | OCH₃ |
| (32) | 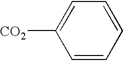 | C₄H₉(t) | H | (CH₂)₂CO₂C₈H₁₇ | H |
| (33) | 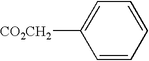 | C₅H₁₁(t) | H | C₅H₁₁(t) | H |
| (34) | 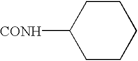 | C₅H₁₁(t) | H | C₅H₁₁(t) | H |
| (35) | 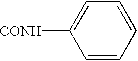 | C₅H₁₁(t) | H | C₅H₁₁(t) | H |
| (36) | PO(OC₂H₅)₂ | C₅H₁₁(t) | H | C₅H₁₁(t) | H |
| (37) | 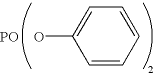 | C₅H₁₁(t) | H | C₅H₁₁(t) | H |
| (38) | 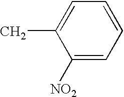 | C₅H₁₁(t) | H | C₅H₁₁(t) | H |
| (39) | 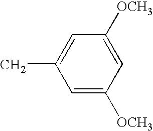 | C₅H₁₁(t) | H | C₅H₁₁(t) | H |
| (40) | Si(CH₃)₃ | C₄H₉(sec) | H | C₄H₉(t) | H |
| (41) | Si(C₂H₅)₃ | C₄H₉(sec) | H | C₄H₉(t) | H |
| (42) | Si(CH₃)₂C₄H₉(t) | C₄H₉(sec) | H | C₄H₉(t) | H |
| (43) | 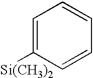 | C₄H₉(sec) | H | C₄H₉(t) | H |
| (44) | 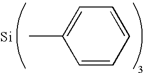 | H | H | C₄H₉(t) | H |
| (45) | Si(CH₃)₃ | C₄H₉(t) | H | C₄H₉(t) | H |

When m=2 in the general formula (1)

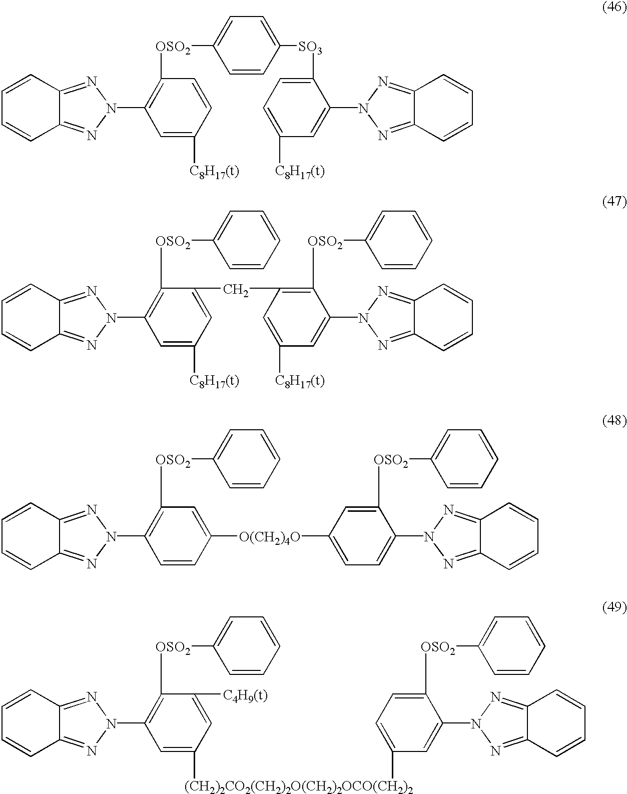

In the heat-sensitive recording material of the invention, the methods for incorporating the UV absorbent precursor represented by the general formula (1) in the light transmittance adjusting layer include: (i) a method of dispersing solids of the precursor, (ii) a method of emulsifying and dispersing the precursor, (iii) a method of dispersing the precursor in a polymer, (iv) a method of dispersing the precursor in a latex, and (v) a method of micro-encapsulating the precursor. Among these, the method of micro-encapsulating the precursor is preferably used.

The addition amount of the UV absorbent precursor represented by the general formula (1) is preferably from 0.05 to 3.0 g/m², and more preferably from 0.1 to 2.0 g/m².

In the method of emulsifying and dispersing the precursor, the UV absorbent precursor represented by the general formula (1) is first dissolved in an oil.

The oil may be in the form of a solid or a liquid at an ordinary temperature and may be a polymer. Examples thereof include a low boiling point auxiliary solvent, such as an acetic ester, methylene chloride and cyclohexanone and/or a phosphoric ester, a phthalic ester, an acrylic ester, a methacrylic ester, other carboxylic esters, a fatty acid amide, an alkylated biphenyl, an alkylated terphenyl, an alkylated naphthalene, a diarylethane, chlorinated paraffin, and an alcohol-type, phenol-type, ether-type, monoolefin-type or epoxy-type oil. Specific examples thereof include a high boiling point oil, such as tricresyl phosphate, trioctyl phosphate, octyldiphenyl phosphate, tricyclohexyl phosphate, dibutyl phthalate, dioctyl phthalate, dilauryl phthalate, dicyclohexyl phthalate, butyl oleate, diethylene glycol benzoate, dioctyl sebacate, dibutyl sebacate, dioctyl adipate, trioctyl trimellitate, acetyltriethyl citrate, octyl maleate, dibutyl maleate, isoamyl biphenyl, chlorinated paraffin, diisopropylnaphthalene, 1,1′-ditolylethane, 2,4-di-t-amylphenol, N,N-dibutyl-2-butoxy-5-t-octylaniline, 2-ethylhexyl hydroxybenzoate and polyethylene glycol. Among these, an alcohol-type oil, a phosphoric ester, a carboxylic ester oil, an alkylated biphenyl, an alkylated terphenyl, an alkylated naphthalene and a diarylethane are preferable. Furthermore, an antioxidant, such as a hindered phenol and hindered amine, may be added to the high boiling point oil.

The oil solution containing the UV absorbent precursor represented by the general formula (1) is added to an aqueous solution of a water-soluble polymer and then emulsified and dispersed using a colloid mill, a homogenizer or ultrasonic wave. The water-soluble polymer such as polyvinyl alcohol may be used, optionally in combination with an emulsion or a latex of a hydrophobic polymer. Examples of the water-soluble polymer include polyvinyl alcohol, silanol-modified polyvinyl alcohol, carboxyl-modified polyvinyl alcohol, a styrene/maleic anhydride copolymer, a butadiene/maleic anhydride copolymer, an ethylene/maleic anhydride copolymer, an isobutylene/maleic anhydride copolymer, polyacrylamide, polystyrene sulfonic acid, polyvinyl pyrrolidone, an ethylene/acrylic acid copolymer and gelatin, and among these, polyvinyl alcohol and gelatin are preferable. Examples of the emulsion or the latex of a hydrophobic polymer include a styrene/butadiene copolymer, a carboxyl-modified styrene/butadiene copolymer and an acrylonitrile/butadiene copolymer. At this point, a conventionally known surfactant may be added as necessary.

The methods of micro-encapsulating the precursor include a known method for forming microcapsules. For example, the UV absorbent precursor represented by the general formula (1) and a microcapsule-wall precursor are dissolved in an organic solvent that is hardly soluble or insoluble in water, and the resultant solution is added to an aqueous solution of the water-soluble polymer, followed by emulsifying and dispersing the precursors and then applying heat, to thereby form a polymeric substance that constitutes a microcapsule-wall at an oil/water interface. Specific examples of the polymeric substance that constitutes the microcapsule-wall include a polyurethane resin, a polyurea resin, a polyamide resin, a polyester resin, a polycarbonate resin, an aminoaldehyde resin, a melamine resin, a polystyrene resin, a styrene/acrylate copolymer resin, a styrene/methacrylate copolymer resin, gelatin and polyvinyl alcohol. Among these, microcapsules having a wall formed with a polyurethane-polyurea resin are particularly preferable.

The microcapsules having a wall formed with a polyurethane-polyurea resin can be produced in the following manner. A microcapsule-wall precursor, such as a polyvalent isocyanate, is admixed with a core substance to be encapsulated, and emulsified and dispersed in an aqueous solution of a water-soluble polymer, such as polyvinyl alcohol. The liquid temperature is then increased to induce a reaction for producing a polymer at an interface of oil droplets.

Representative examples of the polyvalent isocyanate compound include a diisocyanate, such as m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-diphenylmethane-4,4′-diisocyanate, xylene-1,4-diisocyanate, 4,4′-diphenylpropane diisocyanate, trimethylene diisocyanate, hexamethylene diisocyanate, propylene-1,2-diisocyanate, butylene-1,2-diisocyanate, cyclohexylene-1,2-diisocyanate and cyclohexylene-1,4-diisocyanate; a triisocyanate, such as 4,4′,4″-triphenylmethane triisocyanate and toluene-2,4,6-triisocyanate; a tetraisocyanate, such as 4,4′-dimethyldiphenylmethane-2,2′,5,5′-tetraisocyanate; and an isocyanate prepolymer, such as an adduct of hexamethylene diisocyanate and trimethylolpropane, an adduct of 2,4-tolylene diisocyanate and trimethylolpropane, an adduct of xylylene diisocyanate and trimethylolpropane, and an adduct of tolylene diisocyanate and hexanetriol. Two or more kinds thereof may be used in combination, as necessary. Among these, the polyvalent isocyanate compounds having three or more isocyanate groups in the molecule are particularly preferable.

As the organic solvent in which the UV absorbent precursor represented by the general formula (1) is to be dissolved for conducting micro-encapsulation, the oils employed in the method of emulsifying and dispersing the precursor may be used. The water-soluble polymer employed in the method of emulsifying and dispersing the precursor may also be used.

The particle diameter of the microcapsules is preferably from 0.1 to 1.0 μm, and more preferably from 0.2 to 0.7 μm.

In the invention, in order to effectively suppress color formation upon light discoloration, a compound known as the reducing agent may be used in combination with the UV absorbent precursor represented by the general formula (1). When the microcapsules are used, the reducing agent may be present either inside or outside the microcapsules. If it is present outside the microcapsules, the reducing agent is selected from those which spontaneously penetrate within the microcapsules while printing is conducted by applying heat.

Examples of the additive include a hydroquinone-base compound, a hydrazide-base compound, a hydroxyl compound, a phenidone-base compound, a catechol-base compound, a resorcinol-base compound, a hydroxyhydroquinone-base compound, a pyrrologlycitol-base compound, a phenol-base compound, a phenylhydrazide-base compound, a gallic acid-base compound, an ascorbic acid-base compound and an ethylene glycol-base compound. These compounds are described in JP-A Nos. 3-191341, 3-25434, 1-252953, 2-302753, 1-129247, 1-227145, 1-243048 and 2-262649. Specific examples thereof include N-phenylacetohydrazide, N-phenylbutyrylhydrazide, p-t-butylphenol and 2-azidebenzooxazole, as well as the following compounds.

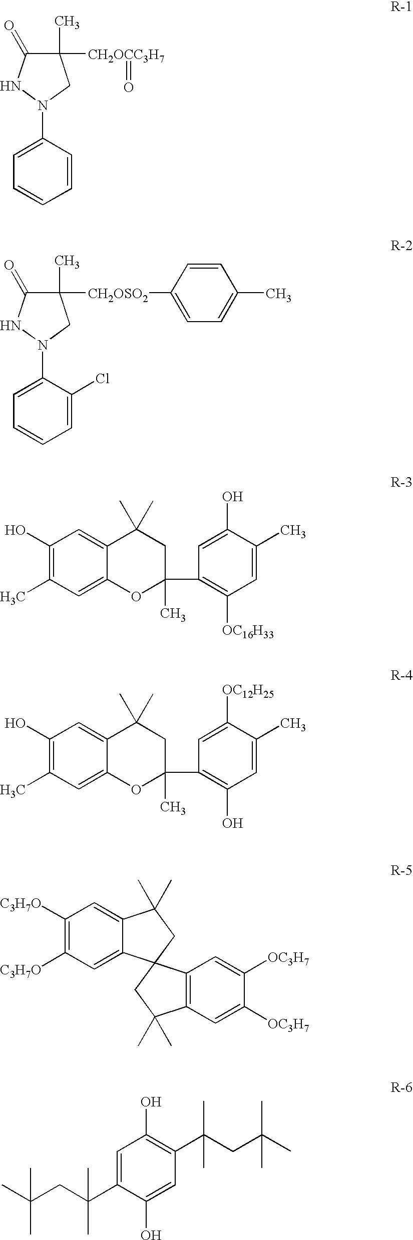

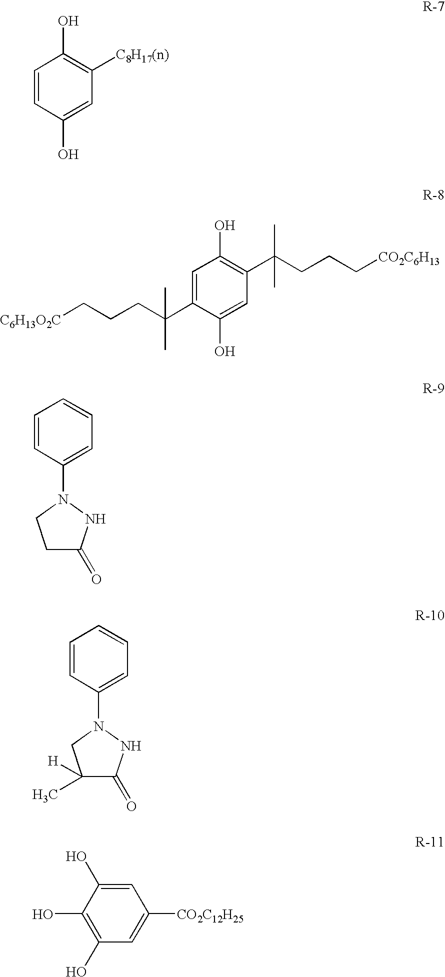

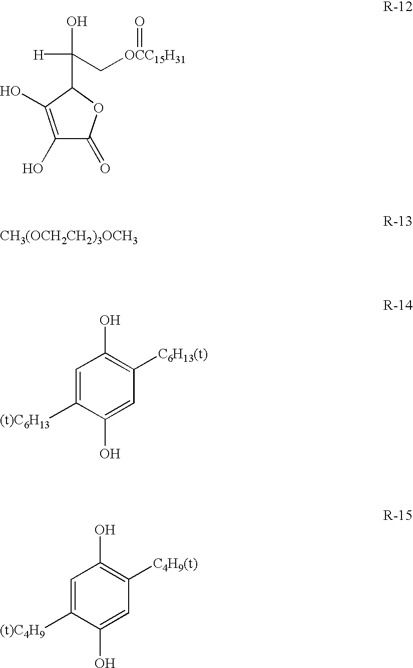

Heat-Sensitive Recording Layer

In the invention, conventionally known color-forming components can be used in the heat-sensitive recording layer. A combination of the diazonium salt compound and the coupler and a combination of the electron-donating dye precursor and the electron-accepting compound are preferably used to cause a reaction for forming color. Particularly, the combination of the diazonium salt compound and the coupler is preferable.

(Diazonium Salt Compound and Coupler)

When the heat-sensitive recording layer contains a diazonium salt compound and a coupler capable of reacting with the diazonium salt compound to form color by applying heat, a basic substance capable of accelerating the color-forming reaction between the diazonium salt compound and the coupler is preferably included in the heat-sensitive recording layer.

The diazonium salt compounds are the compounds represented by the following structural formula, and the maximum absorption wavelength thereof can be controlled by the position and the species of the substituents on the portion represented by Ar,

Ar—N₂⁺X⁻

wherein Ar represents an aryl group, and X⁻ represents an acid anion.

Specific examples of the diazonium salt compound used in the invention include an acid anion salt, such as 4-(N-(2-(2,4-di-tert-amylphenoxy)butyryl)piperazino)benzenediazonium, 4-dioctylaminobenzenediazonium, 4-(N-(2-ethylhexanoyl)piperazino)benzenediazonium, 4-dihexylamino-2-hexyloxybenzenediazonium, 4-N-ethyl-N-hexadecylamino-2-ethoxybenzodiazonium, 3-chloro-4-dioctylamino-2-octyloxybenzenediazonium, 2,5-dibutoxy-4-morpholinobenzenediazonium, 2,5-octoxy-4-morpholinobenzenediazonium, 2,5-dibutoxy-4-(N-(2-ethylhexanoyl)piperazino)benzenediazonium, 2,5-diethoxy-4-(N-(2-(2,4-di-tert-amylphenoxy)butyryl)-piperazino)benzenediazonium, 2,5-dibutoxy-4-tolylthiobenzenediazonium and 3-(2-octyloxyethoxy)-4-morpholinobenzenedizaonium, and the following diazonium salt compounds D-1 to D-5. A hexafluorophosphate salt, a tetrafluoroborate salt and a 1,5-naphthalenesulfonate salt are particularly preferable.

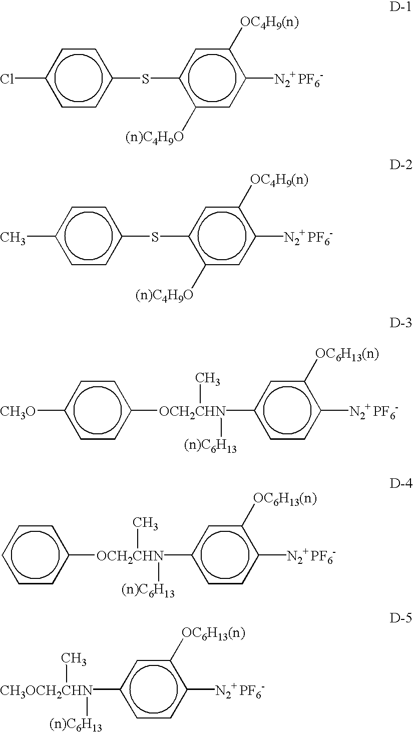

Among these diazonium salt compounds, those photo-decomposed with light having a wavelength of from 300 to 400 nm are particularly preferable in the invention, and examples thereof include 4-(N-(2-(2,4-di-tert-amylphenoxy)butyryl)piperazino) benzenediazonium, 4-dioctylaminobenzenediazonium, 4-(N-(2-ethylhexanoyl)piperazino)benzenediazonium, 4-dihexylamino-2-hexyloxybenzenediazonium, 4-N-ethyl-N-hexadecylamino-2-ethoxybenzodiazonium, 2,5-dibutoxy-4-(N-(2-ethylhexanoyl)piperazino)benzenediazonium, 2,5-diethoxy-4-(N-(2-(2,4-di-tert-amylphenoxy)butyryl)piperazino)benzenediazonium and the above-listed compounds D-3 to D-5. The maximum absorption wavelength of the diazonium salt compound is measured in such a manner that the compound is coated in an amount of from 0.1 to 1.0 g/m², using a spectrophotometer (Shimadzu MPS-2000).

Examples of the coupler used in the invention for forming color through a reaction with the diazonium salt by applying heat include resorcin, fluoroglycin, sodium 2,3-dihydroxynaphthalene-6-sulfonate, 1-hydroxy-2-naphthoic acid morpholinopropylamide, 1,5-dihydroxynaphthalene, 2,3-dihydroxynaphthalene, 2,3-dihydroxy-6-sulfanylnaphthalene, 2-hydroxy-3-naphthoic acid anilide, 2-hydroxy-3-naphthoic acid ethanolamide, 2-hydroxy-3-naphthoic acid octylamide, 2-hydroxy-3-naphthoic acid N-dodecyloxypropylamide, 2-hydroxy-3-naphthoic acid tetradecylamide, acetanilide, acetoacetanilide, benzoylacetanilide, 2-chloro-5-octylacetoacetanilide, 1-phenyl-3-methyl-5-pyrazolone, 1-(2′-octylphenyl)-3-methyl-5-pyrazolone, 1-(2′,4′,6′-trichlorophenyl)-3-benzamide-5-pyrazolone, 1-(2′,4′,6′-trichlorophenyl)-3-anilino-5-pyrazolone, 1-phenyl-3-phenylacetamide-5-pyrazolone and the following compounds C-1 to C-6. These couplers may be used in combination of two or more thereof so as to obtain desired color hues.

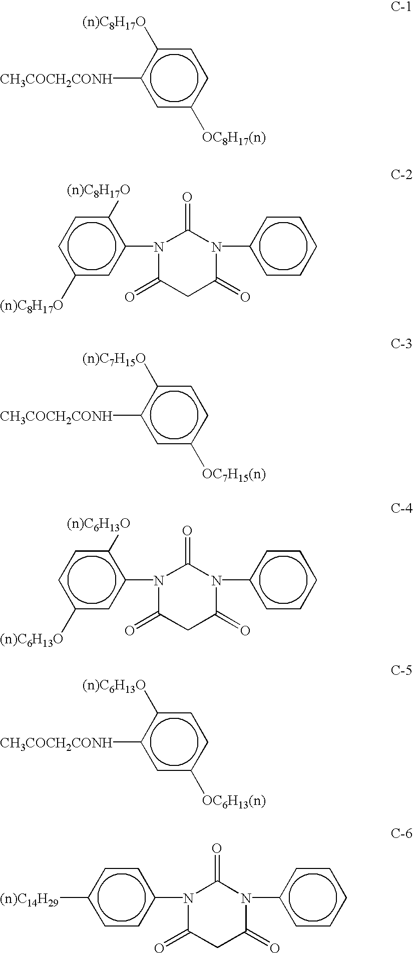

Examples of the basic substance include inorganic and organic basic compounds, and the compounds capable of releasing an alkali substance through decomposition by applying heat are also included. Representative examples thereof include nitrogen-containing compounds, such as an organic ammonium salt, an organic amine, amide, urea and thiourea and the derivatives thereof, thiazoles, pyrroles, pyrimidines, piperazines, guanidines, indoles, imidazoles, imidazolines, triazoles, morpholines, piperidines, amidines, formadines and pyridines. Specific examples thereof include tricyclohexylamine, tribenzylamine, octadecylbenzylamine, stearylamine, allylurea, thiourea, methylthiourea, allylthiourea, ethylenethiourea, 2-benzylimidazole, 4-phenylimidazole, 2-phenyl-4-methylimidazole, 2-undecylimidazoline, 2,4,5-trifuril-2-imidazoline, 1,2-diphenyl-4,4-dimethyl-2-imidazoline, 2-phenyl-2-imidazoline, 1,2,3-triphenylguanidine, 1,2-dicyclohexylguanidine, 1,2,3-tricyclohexylguanidine, guanidine trichloroacetate, N,N′-dibenzylpiperazine, 4,4′-dithiomorpholine, morpholinium trichloroacetate, 2-aminobenzothiazole and 2-benzoylhydrazinobenzothiazole. These may be used in combination of two or more thereof.

(Electron-Donating Dye Precursor and Electron-Accepting Compound)

Examples of the electron-donating dye precursor used in the invention include a triarylmethane-base compound, a diphenylmethane-base compound, a thiazine-base compound, a xanthene-base compound and a spiropyran-base compound. A triarylmethane-base compound and a xanthene compound are particularly useful because of high color density. Some examples thereof include 3,3-bis(p-dimethylaminophenyl)-6-dimetylaminophthalide (i.e., Crystal Violet Lactone), 3,3-bis(p-dimethylamino)phthalide, 3-(p-dimethylaininophenyl)-3-(1,3-dimethylindol-3-yl)-phthalide, 3-(p-dimethylaminophenyl)-3-(2-methylindol-3-yl)phthalide, 3-(o-methyl-p-diethylaminophenyl)-3-(2-methylindol-3-yl)phthalide, 4,4′-bis(dimethylamino)benzhydrinbenzylether, N-halophenyl leuco auramine, N-2,4,5-trichlorophenyl leuco auramine, Rhodamine-B-anilinolactam, Rhodamine-(p-nitroanilino)lactam, Rhodamine-B-(p-chloroanilino)lactam, 2-benzylamino-6-diethylaminofluoran, 2-anilino-6-diethylaminofluoran, 2-anilino-3-methyl-6-diethylaminofluoran, 2-anilino-3-methyl-6-cyclohexylmethylaminofluoran, 2-anilino-3-methyl-6-isoamylethylaminofluoran, 2-(o-chloroanilino)-6-diethylaminofluoran, 2-octylamino-6-diethylaminofluoran, 2-ethoxyethylamino-3-chloro-2-diethylaminofluoran, 2-anilino-3-chloro-6-diethylaminofluoran, benzoyl leuco methylene blue, p-nitrobenzyl leuco methylene blue, 3-methyl-spiro-dinaphthopyran, 3-ethyl-spiro-dinaphthopyran, 3,3′-dicyclo-spiro-dinaphthopyran, 3-benzyl-spiro-dinaphthopiran and 3-propyl-spiro-dibenzopyran.

Examples of the electron-accepting compound include phenol derivatives, salicylic acid derivatives and hydroxybenzoic esters. In particular, bisphenols and hydroxybenzoic esters are preferable. Some examples thereof include 2,2-bis(p-hydroxyphenyl)propane (i.e., bisphenol A), 4,4′-(p-phenylenediisopropylidene)diphenol (i.e., bisphenol P), 2,2-bis(p-hydroxyphenyl)pentane, 2,2-bis(p-hydroxyphenyl)ethane, 2,2-bis(p-hydroxyphenyl)butane, 2,2-bis(4′-hydroxy-3′, 5′-dichlorophenyl)propane, 1,1-(p-hydroxyphenyl)cyclohexane, 1,1-(p-hydroxyphenyl)propane, 1,1-(p-hydroxyphenyl)pentane, 1,1-(p-hydroxyphenyl)-2-ethylhexane, 3,5-di(α-methylbenzyl) salicylic acid and a polyvalent metal salt thereof, 3,5-di(tert-butyl)salicylic acid and a polyvalent metal salt thereof, 3-α,α-dimethylbenzylsalicylic acid and a polyvalent metal salt thereof, butyl p-hydroxybenzoate, benzyl p-hydorxybenzoate, 2-ethylhexyl p-hydroxybenzoate, p-phenylphenol and p-cumylphenol.

When the heat-sensitive recording layer contains an electron-donating dye precursor and an electron-accepting compound, a sensitizer is appropriately included in the heat-sensitive recording layer.

As the sensitizer, a low melting point organic compound that suitably has an aromatic group and a polar group in the molecule is preferable. Representative examples thereof include benzyl p-benzyloxybenzoate, benzyl α-naphthyl ether, benzyl β-naphthyl ether, β-naphthoic acid phenyl ester, α-hydroxy-β-naphthoic acid phenyl ester, β-naphthol-(p-chlorobenzyl)ether, 1,4-butanediolphenyl ether, 1,4-butanediol-p-methylphenyl ether, 1,4-butanediol-p-ethylphenyl ether, 1,4-butanediol-m-methylphenyl ether, 1-phenoxy-2-(p-tolyloxy)ethane, 1-phenoxy-2-(p-ethylphenoxy)ethane, 1-phenoxy-2-(p-chlorophenoxy)ethane and p-benzylbiphenyl.

The use manners of the diazonium salt compound, the coupler capable of reacting with the diazonium salt compound to form color by applying heat, the basic substance, the electron-donating dye precursor, the electron-accepting compound and the sensitizer are not particularly limited in the invention.

Similarly to the UV absorbent precursor represented by the general formula (1), examples of the using method include (i) a method of dispersing solids of the compound, (ii) a method of emulsifying and dispersing the compound, (iii) a method of dispersing the compound in a polymer, (iv) a method of dispersing the compound in a latex, and (v) a method of micro-encapsulating the compound. Among these, the method of micro-encapsulation is preferably employed from the standpoint of storability. Particularly, in the color-forming system utilizing the reaction between the diazonium salt compound and the coupler, it is preferable to micro-encapsulate the diazonium salt compound, while in the color-forming system utilizing the reaction between the electron-donating dye precursor and the electron-accepting compound, it is preferable to micro-encapsulate the electron-donating dye precursor.

In the invention, a plurality of the heat-sensitive recording layers may be laminated, or a multi-color heat-sensitive recording material can be obtained by altering the hues displayed by the respective heat-sensitive recording layers laminated. The layer construction is not particularly limited. For example, there is exemplified a layer construction comprising a support and having successively disposed thereon a heat-sensitive recording layer A containing the electron-donating dye precursor and the electron-accepting compound, and a heat-sensitive recording layer B containing the diazonium salt compound and the coupler capable of reacting with the diazonium salt compound, to thereby produce respective colors.

A multi-color heat-sensitive recording material is also preferable, that is formed by laminating two heat-sensitive recording layers each containing respective diazonium salt compounds having mutually different sensitive wavelengths and respective couplers capable of reacting therewith to form respective colors, and another heat-sensitive recording layer containing the electron-donating dye precursor and the electron-accepting compound. Particularly preferable is a layer construction comprising a support having successively disposed thereon a heat-sensitive recording layer A containing the electron-donating dye precursor and the electron-accepting compound, a heat-sensitive recording layer B containing a diazonium salt compound having a maximum absorption wavelength of 360±20 nm and a coupler capable of reacting therewith to form color by applying heat, and a heat-sensitive recording layer C containing another diazonium salt compound having a maximum absorption wavelength of 400±20 nm and another coupler capable of reacting therewith to form color, the heat-sensitive recording layer A, the heat-sensitive recording layer B, and the heat-sensitive recording layer C constituting a laminated structure. Owing to this layer construction, full-color image recording can be achieved by selecting color hues of the respective heat-sensitive recording layers as the three primary colors for subtractive color process, i.e., yellow, magenta and cyan.

The recording process using this multi-color heat-sensitive recording material is implemented as follows. First, the heat-sensitive recording layer C is heated to cause a reaction between the diazonium salt compound and the coupler contained therein to form color. Then, the material is irradiated with light having a wavelength of 400±20 nm to decompose the unreacted diazonium salt compound remaining in the heat-sensitive recording layer C, after which a sufficient amount of heat is applied to the heat-sensitive recording layer B to form color by causing a reaction between the diazonium salt and the coupler contained therein. At this point, the heat-sensitive recording layer C is also strongly heated, but it does not form color because the diazonium salt compound has already been decomposed, and thus the color-forming ability of the layer has been lost. The material is further irradiated with light having a wavelength of 360±20 nm to decompose the unreacted diazonium salt compound remaining in the heat-sensitive recording layer B, and finally, a sufficient amount of heat is applied to the heat-sensitive recording layer A to form color. At this point, the heat-sensitive recording layers B and C are also strongly heated, but they do not form color because the diazonium salt compounds contained therein have already been decomposed, and thus the color-forming ability of the layers has been lost.

In the invention, antioxidants may be used to improve light fastness. Examples of the antioxidant include those described in EP-A No. 310,551, GP-A No. 3,435,443, EP-A No. 310,552, JP-A No. 3-121449, EP-A No. 459,416, JP-A Nos. 2-262654, 2-71262 and 63-163351, U.S. Pat. No. 4,814,262, JP-A Nos. 54-48535, 5-61166 and 5-119449, U.S. Pat. No. 4,980,275, JP-A Nos. 63-113536 and 62-262047, and EP-A Nos. 223,739, 309,402 and 309,401.

Additional examples of the antioxidant include the compounds described in JP-A Nos. 60-125470, 60-125471, 60-125472, 60-287485, 60-287486, 60-287487, 62-146680, 60-287488, 62-282885, 63-89877, 63-88380, 63-88381, 1-239282, 4-291685, 4-291684, 5-188687, 5-188686, 5-110490, 5-1108437, 5-170361, 63-203372, 63-224989, 63-267594, 63-182484, 60-107384, 60-107383, 61-160287, 61-185483, 61-211079, 63-251282 and 63-51174, and JP-B Nos. 48-43294 and 48-33212.

Specifically, examples thereof include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4-tetrahydroquinoline, nickel cyclohexanoate, 2,2-bis-4-hydroxyphenylpropane, 1,1-bis-4-hydroxyphenyl-2-ethylhexane, 2-methyl-4-methoxy-diphenylamine, 1-methyl-2-phenylindole and the following compounds.

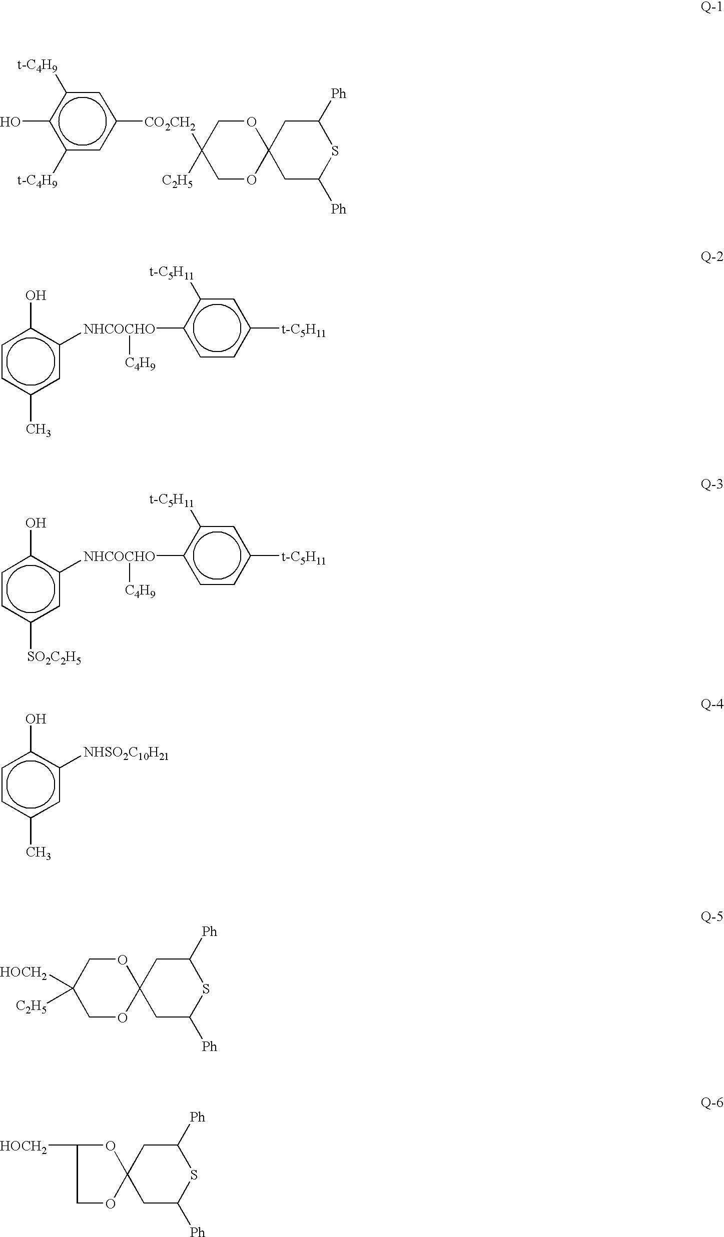

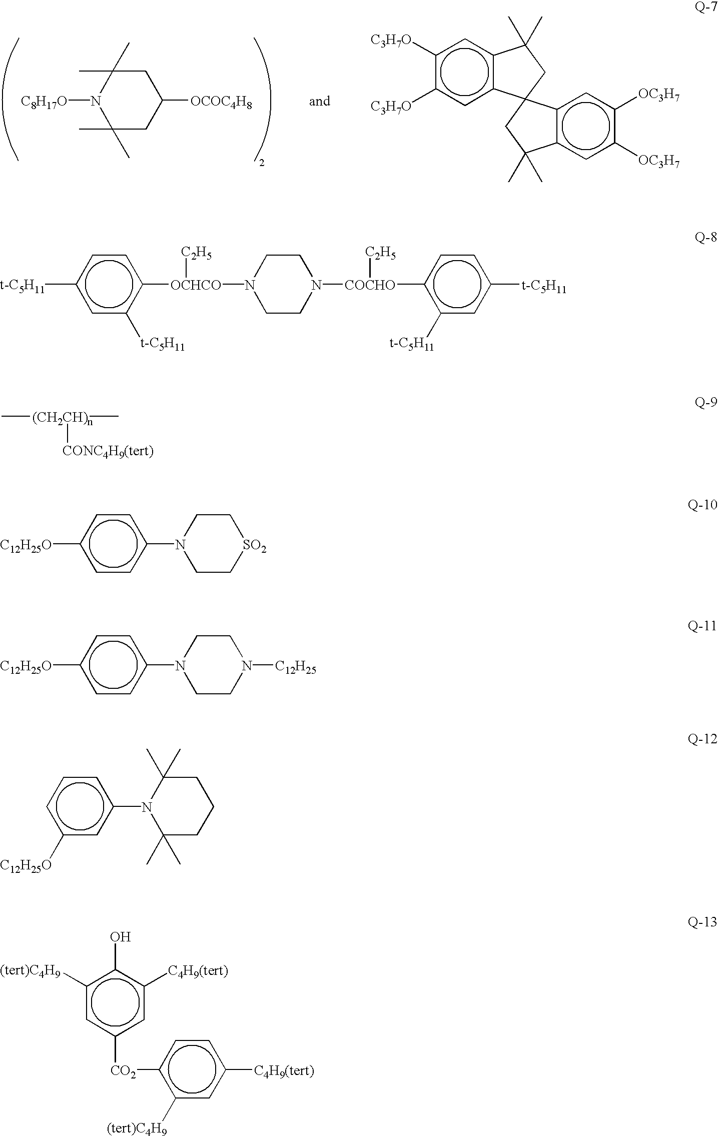

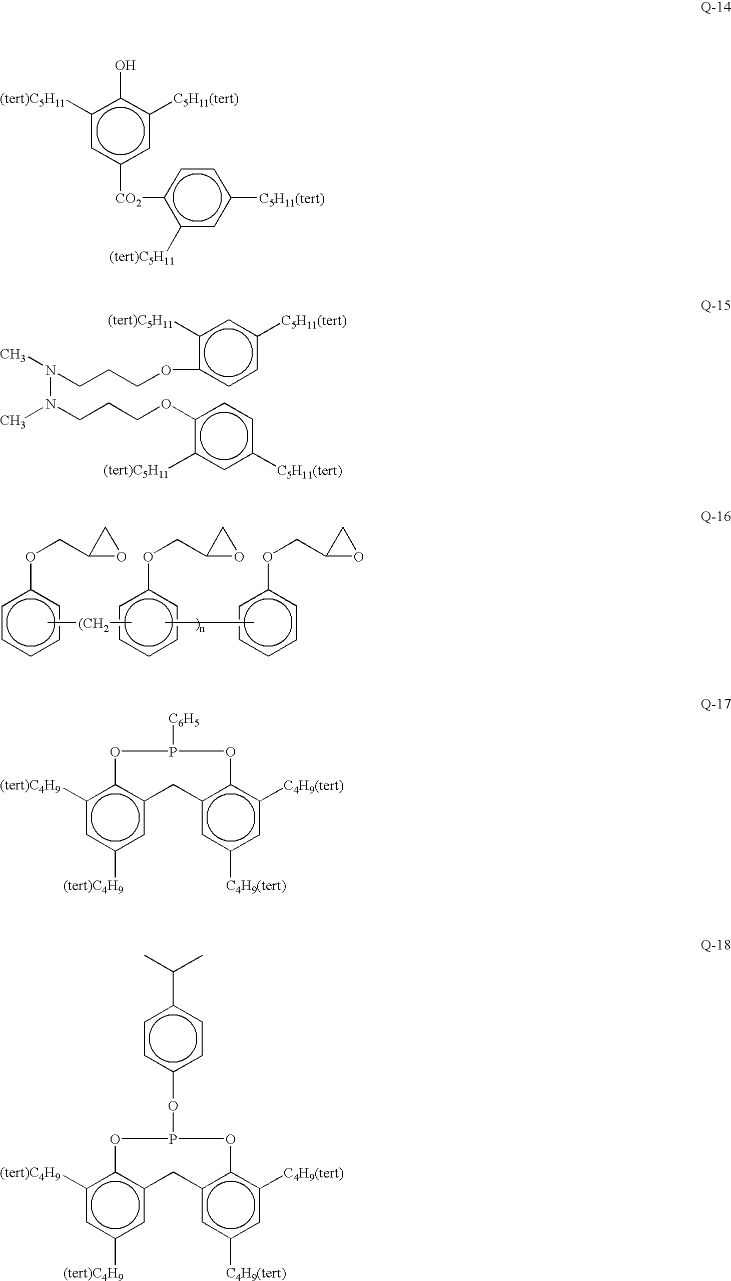

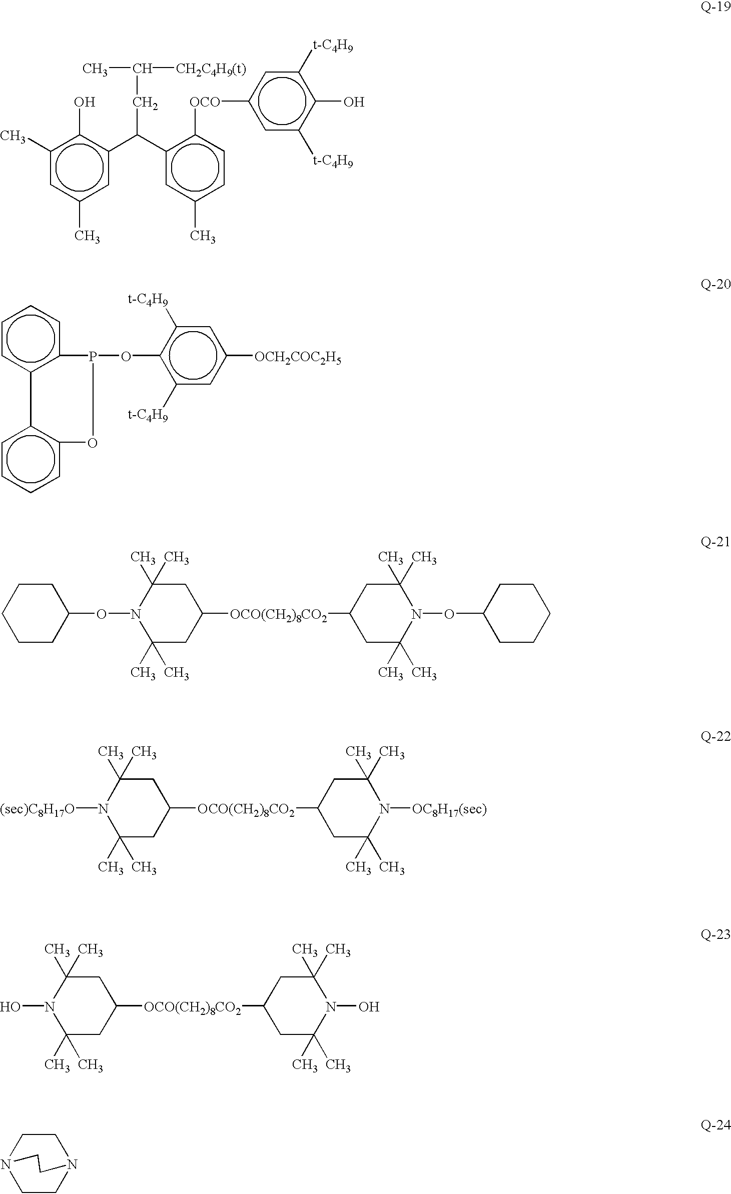

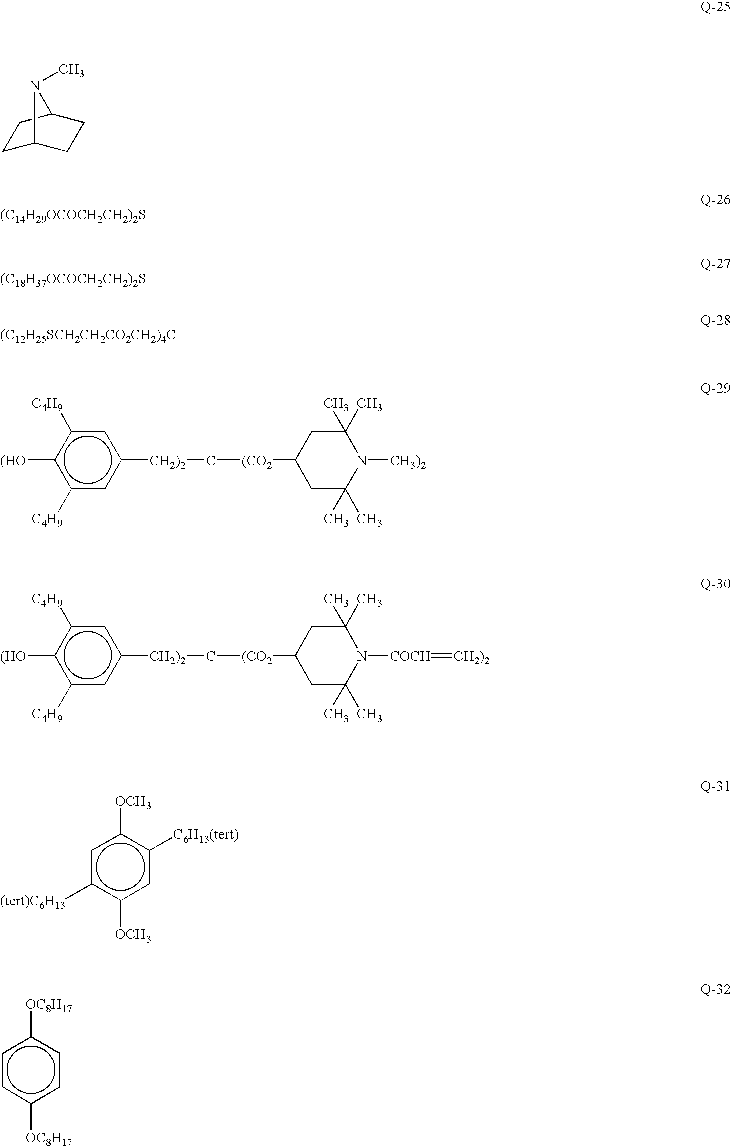

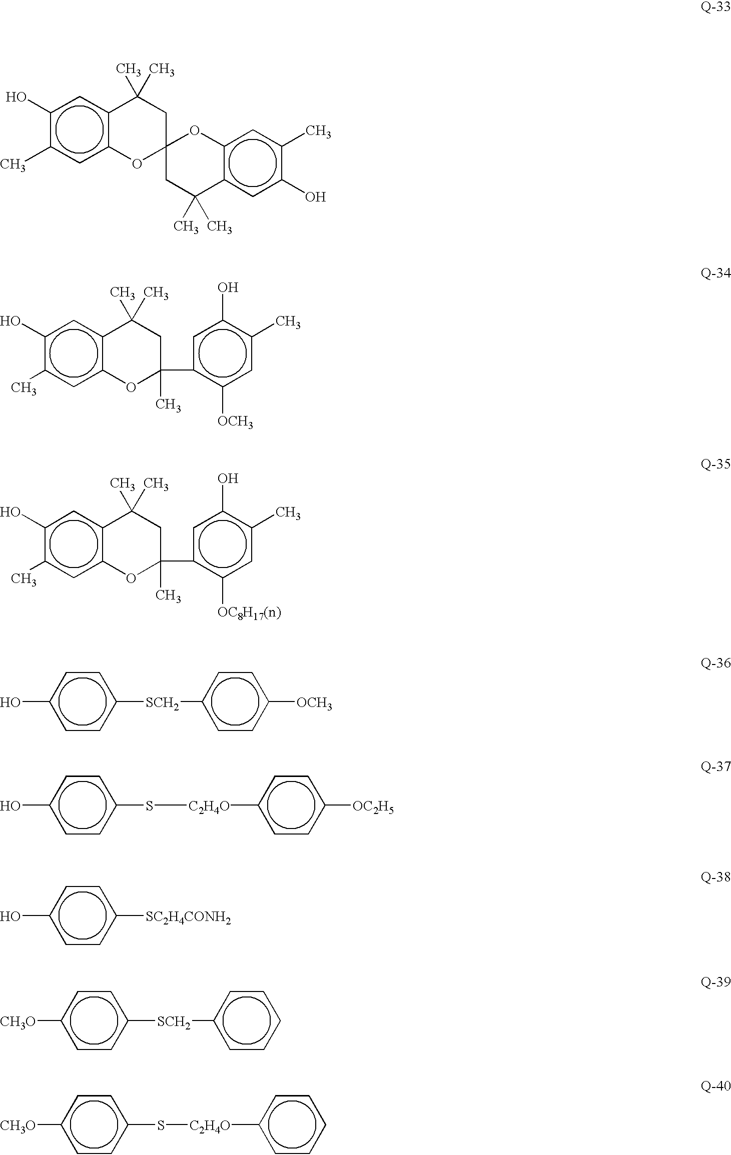

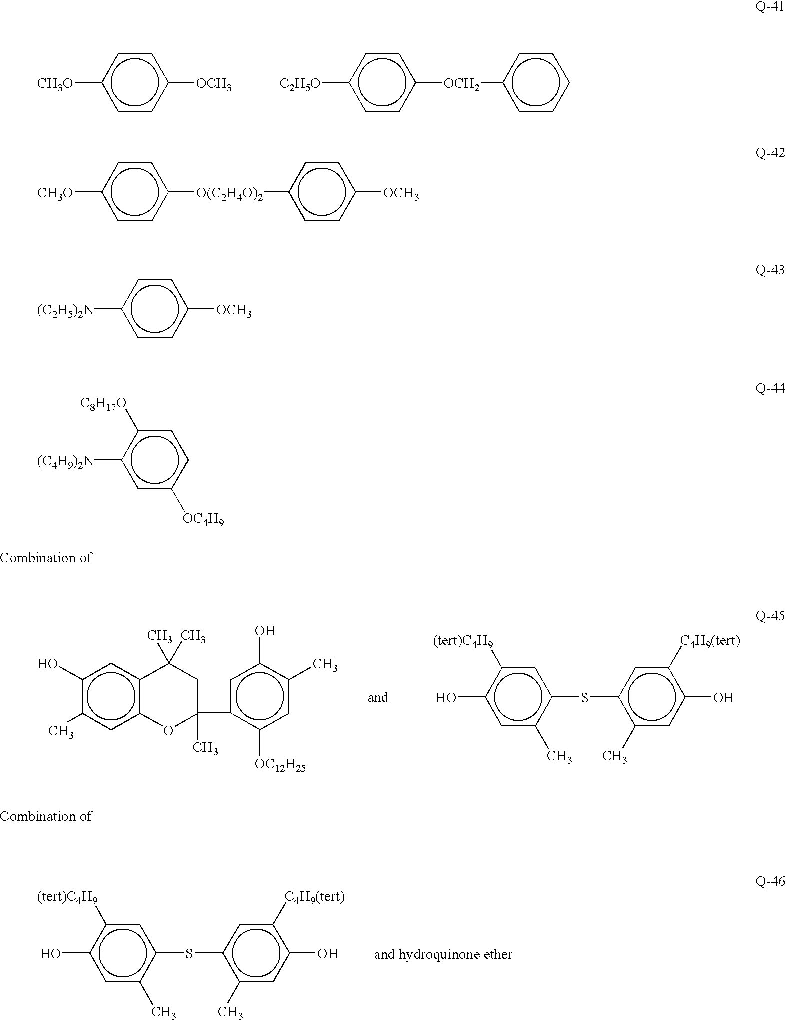

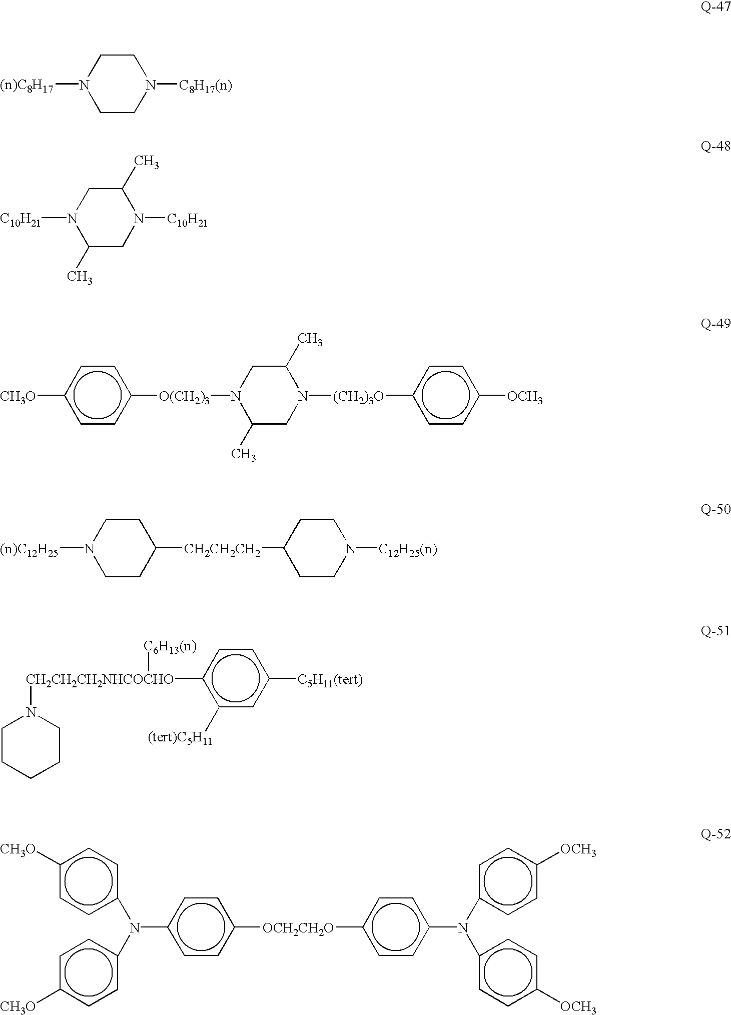

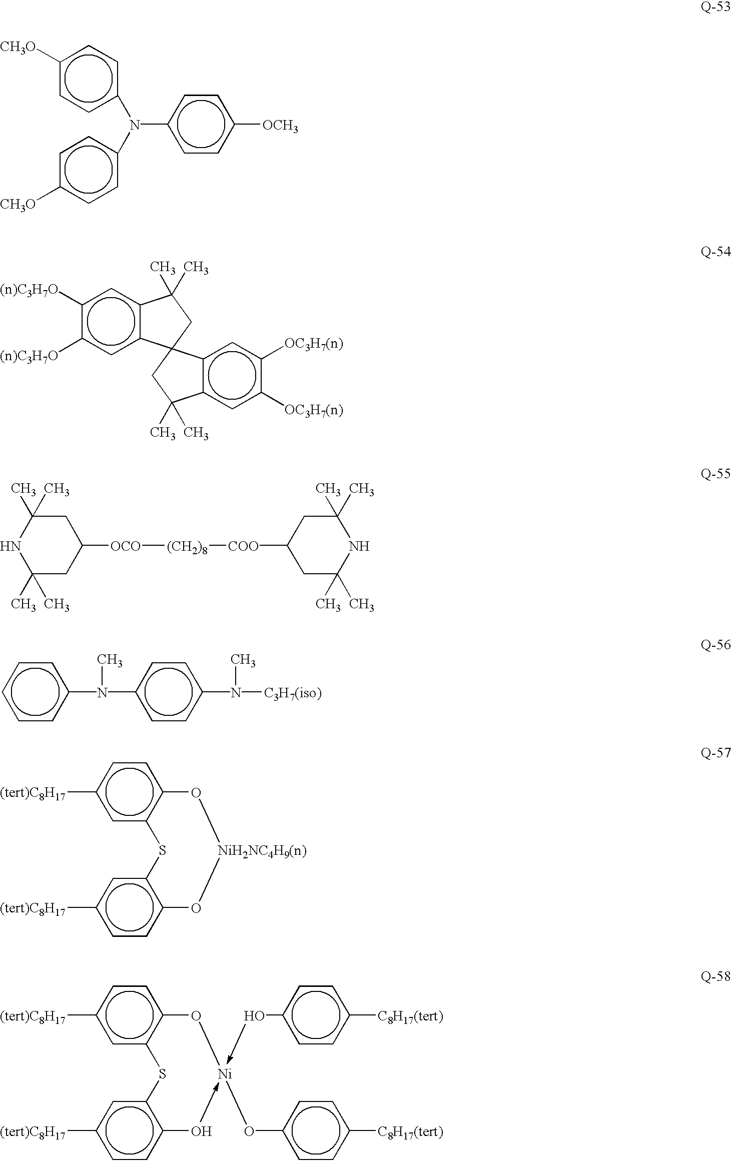

These antioxidants may be included in the heat-sensitive recording layer, the intermediate layer or the protective layer. If the antioxidants are used in combination thereof, use of the compound Q-7, Q-45, Q-46 or Q-10 together with the compound Q-13 is preferable.

Support

As the support, a plastic film, paper, plastic resin laminated paper, synthetic paper and the like can be used in the invention.

Intermediate Layer

When the heat-sensitive coloring layers exhibiting different kinds of hues are laminated in the invention, an intermediate layer may be provided to inhibit color mixing. A water-soluble polymer compound may be included in the intermediate layer. Examples thereof include polyvinyl alcohol, modified polyvinyl alcohol, methyl cellulose, sodium polystyrenesulfonate, a styrene/maleic acid copolymer and gelatin.

Protective Layer

In the protective layer, water-soluble polymer compounds may be used as employed in the intermediate layer. In order to improve compatibility with a thermal head, a pigment, a metallic soap, wax, a water proofing agent and a releasing agent may be added. A surfactant may also be included in a coating solution for the protective layer when the solution is applied on the heat-sensitive coloring layer to obtain a uniform protective layer. Examples of the surfactant include an alkali metallic salt of sulfosuccinic acid series and a fluorine-containing surfactant. Specifically, a sodium salt or an ammonium salt of di(n-hexyl)sulfosuccinic acid or di(2-ethylhexyl)sulfosuccinic acid is preferable, but any anionic surfactant may be used effectively.

### EXAMPLES

The invention will be described in more detail by way of examples given below, but the invention is not construed as being limited thereto. In the following examples, “parts” and “%” are all by mass unless otherwise indicated.

### Example 1

Preparation of Phthalated Gelatin Solution

32 parts of phthalated gelatin (MGP GELATIN, a trade name, produced by Nippi Collagen Co., Ltd.) and 0.9143 part of 1,2-benzothiazolin-3-one (3.5% methanol solution, produced by Daito Chemix Corp.) were mixed and dissolved in 367.1 parts of ion exchanged water at 40° C. to obtain an aqueous solution of phthalated gelatin.

Preparation of Alkali-Treated Gelatin Solution

25.5 parts of alkali-treated low ionic gelatin (#750 GELATIN, a trade named, produced by Nitta Gelatin Inc.), 0.7286 part of 1,2-benzothiazolin-3-one (3.5% methanol solution, produced by Daito Chemix Corp.) and 0.153 part of calcium hydroxide were mixed and dissolved in 143.6 parts of ion exchanged water at 50° C. to obtain an aqueous solution of alkali-treated gelatin.

(1) Preparation of Coating Composition (a) for Yellow Color Forming Heat-Sensitive Recording Layer

Preparation of Diazonium Salt Compound-Containing Microcapsule Composition (a)

4.4 part of the following diazonium salt compound (A) (maximum absorption wavelength: 420 nm), 4.8 parts of monoisopropylbiphenyl, 4.8 parts of diphenyl phthalate and 0.4 part of diphenyl-(2,4,6-trimethylbenzoyl)phosphineoxide (LUCIRIN TPO, a trade name, produced by BASF Japan Ltd.) were added to 16.1 parts of ethyl acetate and thoroughly dissolved by heating the mixture to 40° C. 8.6 parts of another mixture of an adduct of xylylene diisocyanate and trimethylolpropane and an adduct of xylylene diisocyanate and bisphenol A (TAKENATE D 119N, 50% ethyl acetate solution, a trade name, produced by Takeda Chemical Industries, Ltd.) as a capsule-wall material was added to the above mixture and thoroughly stirred, to obtain a mixed solution (I).

Diazonium Salt Compound (A)

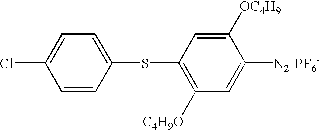

Separately, 16.3 parts of ion exchanged water and 0.34 part of SCRAPH AG-8 (50%) (produced by Nippon Fine Chemical Co., Ltd.) were added to 58.6 parts of the phthalated gelatin aqueous solution, to obtain a mixed solution (II).

The mixed solution (I) was added to the mixed solution (II) and subjected to emulsification using a homogenizer (Nippon Seiki Co., Ltd.) at 40° C. 20 parts of water was added to the obtained emulsion, and after being homogenized, the resulting mixture was stirred at 40° C. and subjected to an encapsulating reaction for 3 hours while removing ethyl acetate. Thereafter, 4.1 parts of an ion exchange resin (AMBERLITE IRA68, produced by Organo Corp.) and 8.2 parts of an ion exchange resin (AMBERLITE IRC50, produced by Organo Corp.) were added thereto and further stirred for 1 hour. Thereafter, the ion exchange resins were removed by filtration, and the concentration was adjusted to make a solids concentration of the capsule composition of 20.0% to obtain a diazonium salt compound-containing microcapsule composition (a). The produced microcapsules had a particle diameter of 0.36 μm in terms of median diameter as a result of the particle diameter measurement using LA-700 (produced by Horiba, Ltd.).

Preparation of Coupler Compound Emulsion (a)

9.9 parts of the following coupler compound (C), 9.9 parts of triphenylguanidine (produced by Hodogaya Chemical Co., Ltd.), 20.8 parts of 4,4′-(m-phenylenediisopropylidene)diphenol (BISPHENOL M, a trade name, produced by Mitsui Petrochemical Industries, Ltd.), 3.3 parts of 3,3,3′,3′-tetramethyl-5,5′,6,6′-tetra(1-propyloxy)-1,1′-spirobisindane, 13.6 parts of 4-(2-ethylhexyloxy)benzenesulfonic acid amide (produced by Manac Inc.), 6.8 parts of 4-n-pentyloxybenzenesulfonic acid amide (produced by Manac Inc.), and 4.2 parts of calcium dodecylbenzenesulfonate (PIONIN A-41-C, 70% methanol solution, a trade name, produced by Takemoto Oil & Fat Co., Ltd.) were dissolved in 33.0 parts of ethyl acetate, to obtain a mixed solution (III).

Coupler Compound (C)

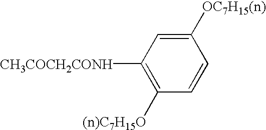

Separately, 107.3 parts of ion exchanged water was mixed with 206.3 parts of the alkali-treated gelatin aqueous solution, to obtain a mixed solution (IV).

The mixed solution (III) was added to the mixed solution (IV) and subjected to emulsification using a homogenizer (Nippon Seiki Co., Ltd.) at 40° C. The obtained coupler compound emulsion was heated under reduced pressure to remove ethyl acetate, and the concentration was adjusted to a solids concentration of 26.5%. The resultant coupler compound emulsion had a particle diameter of 0.21 μm in terms of median diameter as a result of the particle diameter measurement using LA-700 (produced by Horiba, Ltd.).

9 parts of SBR latex (SN-307, 48% solution, a trade name, produced by Sumika ABS & Latex Inc.) pre-adjusted to a concentration of 26.5% was added to 100 parts of the resultant coupler compound emulsion and thoroughly stirred to obtain a coupler compound emulsion (a).

Preparation of Coating Composition (a)

The diazonium salt compound-containing microcapsule composition (a) and the coupler compound emulsion (a) were mixed to make a mass ratio of the coupler compound to the encapsulated diazo compound of 3/1, to thereby obtain a coating composition (a) for a yellow color forming heat-sensitive recording layer.

(2) Preparation of Coating Composition (b) for Magenta Color Forming Heat-Sensitive Recording Layer

Preparation of Diazonium Salt Compound-Containing Microcapsule Composition (b)

3.2 part of the following diazonium salt compound (D) (maximum absorption wavelength: 365 nm), 3.8 parts of diphenyl phthalate, 3.9 parts of phenyl 2-benzoyloxybenzoic ester, 4.2 parts of the following compound (E) (LIGHTESTER TMP, a trade name, produced by Kyoei Ushi Kagaku Co., Ltd.) and 0.1 part of calcium dodecylbenzenesulfonate (PIONIN A-41-C, 70% methanol solution, a trade name, produced by Takemoto Oil & Fat Co., Ltd.) were added to 15.1 parts of ethyl acetate and thoroughly dissolved by heating. 2.5 parts of a mixture of an adduct of xylylene diisocyanate and trimethylolpropane and an adduct of xylylene diisocyanate and bisphenol A (TAKENATE D119N, 50% ethyl acetate solution, a trade name, produced by Takeda Chemical Industries, Ltd.) and 6.8 parts of an adduct of xylylene diisocyanate and trimethylolpropane (TAKENATE D110N, 75% ethyl acetate solution, a trade name, produced by Takeda Chemical Industries, Ltd.) as a capsule-wall material was added to the resultant mixed solution and thoroughly stirred, to obtain a mixed solution (V).

Diazonium Salt Compound (D)

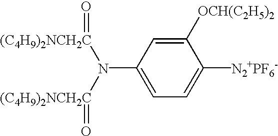

Compound (E)

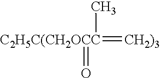

Separately, 21.0 parts of ion exchanged water was added to 55.3 parts of the phthalated gelatin aqueous solution, to obtain a mixed solution (VI).

The mixed solution (V) was added to the mixed solution (VI) and subjected to emulsification using a homogenizer (Nippon Seiki Co., Ltd.) at 40° C. 24 parts of water was added to the obtained emulsion, and after being homogenized, the mixture was stirred at 40° C. and subjected to an encapsulating reaction for 3 hours while removing ethyl acetate. Thereafter, 4.1 parts of an ion exchange resin (AMBERLITE IRA68, produced by Organo Corp.) and 8.2 parts of an ion exchange resin (AMBERLITE IRC50, produced by Organo Corp.) were added thereto and further stirred for 1 hour. Thereafter, the ion exchange resins were removed by filtration, and the concentration was adjusted to make a solids concentration of the capsule composition of 20.0% to obtain a diazonium salt compound-containing microcapsule composition (b). The resultant microcapsules had a particle diameter of 0.50 μm in terms of median diameter as a result of the particle diameter measurement using LA-700 (produced by Horiba, Ltd.).

Preparation of Coupler Compound Emulsion (b)

11.9 parts of the following coupler compound (F), 28.0 parts of triphenylguanidine (produced by Hodogaya Chemical Co., Ltd.), 14.0 parts of 4,4′-(m-phenylenediisopropylidene)diphenol (BISPHENOL M, a trade name, produced by Mitsui Petrochemical Industries, Ltd.), 14.0 parts of 1,1-(p-hydroxyphenyl)-2-ethylhexane, 3.5 parts of 3,3,3′,3′-tetramethyl-5,5′,6,6′-tetra(1-propyloxy)-1,1′-spirobisindane, 3.5 parts of the following compound (G), 1.7 parts of tricresyl phosphate, 0.8 part of diethyl maleate and 4.5 parts of calcium dodecylbenzenesulfonate (PIONIN A-41-C, 70% methanol solution, a trade name, produced Takemoto Oil & Fat Co., Ltd.) were dissolved in 36.9 parts of ethyl acetate, to obtain a mixed solution (VII).

Coupler Compound (F)

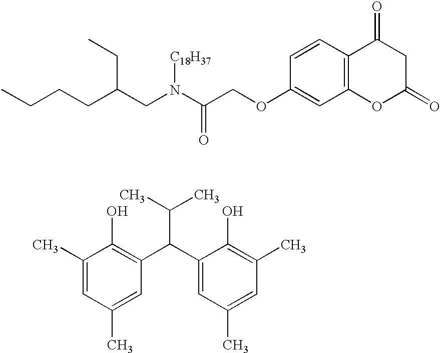

Separately, 107.3 parts of ion exchanged water was mixed with 206.3 parts of the alkali-treated gelatin aqueous solution, to obtain a mixed solution (VIII).

The mixed solution (VII) was added to the mixed solution (VIII) and subjected to emulsification using a homogenizer (Nippon Seiki Co., Ltd.) at 40° C. The obtained coupler compound emulsion was heated under reduced pressure to remove ethyl acetate, and the concentration was adjusted to a solids concentration of 24.5% to obtain a coupler compound emulsion (b). The resultant coupler compound emulsion had a particle diameter of 0.22 μm in terms of median diameter as a result of the particle diameter measurement using LA-700 (produced by Horiba, Ltd.).

Preparation of Coating Composition (b)

The diazonium salt compound-containing microcapsule composition (b) was mixed with the coupler compound emulsion (b) to make a mass ratio of the coupler compound to the encapsulated diazo compound of 3.5/1, to thereby obtain a coating composition (b) for a magenta color forming heat-sensitive recording layer.

(3) Preparation of Coating Composition (c) for Cyan Color Forming Heat-Sensitive Recording Layer

Preparation of Electron-Donating Dye Precursor-Containing Microcapsule Composition (c)

7.6 parts of the following electron-donating dye precursor (H), 8.0 parts of a mixed solution of 1-methylpropylphenyl-phenylmethane and 1-(1-methylpropylphenyl)-2-phenylethane (HISOL SAS-310, a trade name, produced by Nippon Oil Co., Ltd.) and 8.0 parts of the following compound (I) (IGRAPERM 2140, a trade name, produced by Ciba-Geigy) were added to 18.1 parts of ethyl acetate and thoroughly dissolved by heating.

3.2 parts of an adduct of xylylene diisocyanate and trimethylolpropane (TAKENATE D110N, 75% ethyl acetate solution, a trade name, produced by Takeda Chemical Industries, Ltd.) and 8.3 parts of polymethylene polyphenylpolyisocyanate (MILLIONATE MR-20, a trade name, produced by Nippon Polyurethane Co., Ltd.) as a capsule-wall material was added to the resultant mixture and thoroughly stirred, to obtain a mixed solution (IX).

Electron-Donating Dye Precursor (H)

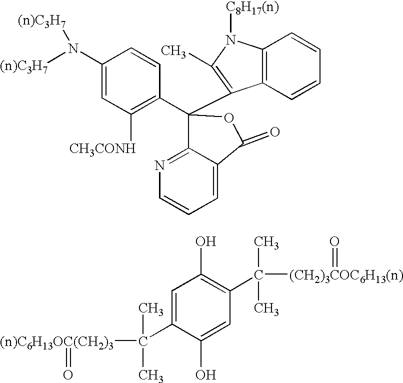

Separately, 9.5 parts of ion exchanged water, 0.17 part of SCRAPH AG-8 (50%) (produced by Nippon Fine Chemical Co., Ltd.) and 4.3 parts of sodium dodecylbenzenesulfonate (10% aqueous solution) were added to 28.8 parts of the phthalated gelatin aqueous solution, to obtain a mixed solution (X).

The mixed solution (IX) was added to the mixed solution (X) and subjected to emulsification using a homogenizer (Nippon Seiki Co., Ltd.) at 40° C. 50 parts of water was added to the obtained emulsion, and after being homogenized, the mixture was stirred at 65° C. and subjected to an encapsulating reaction for 3 hours with removing ethyl acetate. The concentration of the capsule composition was adjusted to make a solids concentration of 33% to obtain a microcapsule composition. The produced microcapsules had a particle diameter of 1.10 μm in terms of median diameter as a result of the particle diameter measurement using LA-700 (produced by Horiba, Ltd.).

Furthermore, 3.7 parts of a 25% aqueous solution of sodium dodecylbenzenesulfonate (NEOPELEX F-25, a trade name, produced by Kao Corp.) and 4,4′-bistriazinylaminostilbene-2,2′-disulfone derivative (KAYCALL BXNL, a trade name, produced by Nippon Soda Co., Ltd.) were added to 100 parts of the microcapsule composition and thoroughly stirred to thereby obtain a microcapsule dispersion (c).

Preparation of Electron-Accepting Compound Dispersion (c)

30.1 parts of ion exchanged water, 22.5 parts of 4,4′-(p-phenylenediisopropylidene)diphenol (BISPHENOL P, a trade name, produced by Mitsui Petrochemical Industries, Ltd.) and 3.8 parts of a 2% aqueous solution of sodium ethylhexylsucciniate were added to 11.3 parts of the phthalated gelatin aqueous solution, and the mixture was dispersed using a ball mill overnight to obtain a dispersion. The dispersion had a solids concentration of 26.6%.

45.2 parts of the alkali-treated gelatin aqueous solution was added to 100 parts of the obtained dispersion, and after stirring for 30 minutes, ion exchanged water was added thereto in such an amount that the solids concentration of the dispersion was 23.5%, whereby an electron-accepting compound dispersion (c) was produced.

Preparation of Coating Composition (c)

The electron-donating dye precursor-containing microcapsule composition (c) was mixed with the electron-accepting compound dispersion (c) to make a mass ratio of the electron-accepting compound to the electron-donating dye precursor of 15/1, to thereby obtain a coating composition (c) for a cyan color forming heat-sensitive recording layer.

(4) Preparation of Coating Composition for Intermediate Layer

100.0 parts of alkali-treated low ionic gelatin (#750 GELATIN, a trade named, produced by Nitta Gelatin Inc.), 2.857 parts of 1,2-benzothiazolin-3-one (3.5% methanol solution, produced by Daito Chemix Corp.) and 0.5 part of calcium hydroxide were mixed and dissolved in 521.643 parts of ion exchanged water at 50° C. to obtain a gelatin aqueous solution for producing an intermediate layer.

10.0 parts of the gelatin aqueous solution for producing an intermediate layer, 0.05 part of sodium (4-nonylphenoxytrioxyethylene)butylsulfonate (2.0% aqueous solution, produced by Sankyo Chemical Co., Ltd.), 2 parts of boric acid (4.0% aqueous solution), 0.19 part of a 5% aqueous solution of polystyrenesulfonic acid (partially neutralized with potassium hydroxide), 3.42 parts of a 4% aqueous solution of the following compound (J) (produced by Wako Pure Chemical Industries, Ltd.), 1.13 parts of a 4% aqueous solution of the following compound (J′) (produced by Wako Pure Chemical Industries, Ltd.) and 0.67 part of ion exchanged water were mixed to form a coating composition for an intermediate layer.

Compound (J)

CH₂═CH—SO₂CH₂CONH—(CH₂)₂—NHCOCH₂SO₂—CH═CH₂

Compound (J′)

CH₂═CH—SO₂CH₂CONH—(CH₂)₃—NHCOCH₂SO₂—CH═CH₂

(5) Preparation of Coating Composition for Light Transmittance Adjusting Layer

Preparation of UV absorbent Precursor Microcapsule Composition

47 parts of the following UV absorbent precursor A, 16 parts of 2,5-bis(t-octyl)hydroquinone, 6 parts of tricresyl phosphate, 19 parts of α-methylstyrene dimer (MSD-100, a trade name, produced by Mitsui Chemicals, Inc.) and 1.6 parts of calcium dodecylbenzenesulfonate (PIONIN A-41-C, 70% methanol solution, a trade name, produced by Takemoto Oil & Fat Co., Ltd.) were thoroughly dissolved in 155 parts of ethyl acetate. 94 parts of an adduct of xylylene diisocyanate and trimethylolpropane (TAKENATE D110N, 75% ethyl acetate solution, a trade name, produced by Takeda Chemical Industries, Ltd.) as a capsule-wall material was added to the resultant mixed solution and thoroughly stirred, so as to obtain a UV absorbent precursor mixed solution.

UV Absorbent Precursor A

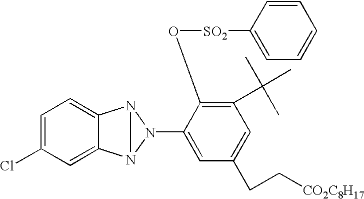

Separately, 17 parts of a 30% phosphoric acid aqueous solution and 1,038.5 parts of ion exchanged water were mixed with 99.5 parts of itaconic acid-modified polyvinyl alcohol (KL-318, a trade name, produced by Kuraray Co., Ltd.) to prepare a PVA aqueous solution for a UV absorbent precursor microcapsule composition.

The entire amount of the UV absorbent precursor mixed solution was added to the entire amount of the PVA aqueous solution for the UV absorbent precursor microcapsule composition and subjected to emulsification using a homogenizer (Nippon Seiki Co., Ltd.) at 20° C. 510 parts of ion exchanged water was added to the obtained emulsion, and after being homogenized, the mixture was stirred at 40° C. and subjected to an encapsulating reaction for 3 hours. Thereafter, 100 parts of an ion exchange resin (AMBERLITE MB-3, produced by Organo Corp.) was added thereto and further stirred for 1 hour. Then, the ion exchange resin was removed by filtration, and the concentration was adjusted to make a solids concentration of the capsule composition of 13% to obtain a UV absorbent precursor microcapsule composition.

Preparation of Coating Composition for Light Transmittance Adjusting Layer

10.0 parts of a 4% sodium hydroxide aqueous solution and 73.39 parts of sodium 4-(4-nonylphenoxy)trioxyethylene)butylsulfonate (2.0% aqueous solution, produced by Sankyo Chemical Co., Ltd.) were mixed with 1,000 parts of the UV absorbent precursor microcapsule composition to obtain a coating composition for a light transmittance adjusting layer.

(6) Preparation of Coating Composition for Protective Layer

Preparation of Polyvinyl Alcohol Solution for Protective Layer

160 parts of a vinyl alcohol/alkyl vinyl ether copolymer (EP-130, a trade name, produced by Denki Kagaku Kogyo K.K.), 8.74 parts of a mixed solution of sodium alkylbenzenesulfonate and polyoxyethyelene alkyl ether phosphoric ester (NEOSCORE CM-57, a trade name, 54% aqueous solution, produced by Toho Chemical Industry Co., Ltd.) and 3,832 parts of ion exchanged water were mixed and dissolved at 90° C. for 1 hour to obtain a uniform polyvinyl alcohol solution for a protective layer.

Preparation of Pigment Dispersion for Protective Layer

0.2 part of a specific anionic polycarboxylic acid-type polymer surfactant (POISE 532A, 40% aqueous solution, a trade name, produced by Kao Corp.) and 11.8 parts of ion exchanged water were added to 8 parts of barium sulfate (BF-21F, a trade name, produced by Sakai Chemical Industry Co., Ltd., barium sulfate content: 93% or more) and dispersed using a Dyenomill to prepare a barium sulfate dispersion. The dispersion had a particle diameter of 0.15 μm or less in terms of median diameter as a result of the particle diameter measurement using LA-910 (produced by Horiba, Ltd.).

16.2 parts of colloidal silica (SNOWTEX O, a trade name, produced by Nissan Chemical Industries, Ltd., 20% aqueous dispersion) was added to 45.6 parts of the barium sulfate dispersion to obtain a pigment dispersion for a protective layer.

Preparation of Matting Agent Dispersion for Protective Layer

3.81 parts of an aqueous dispersion of 1,2-benzisothiazolin-3-one (PROXEL B.D., a trade name, produced by I.C.I Japan Ltd.) and 1,976.19 parts of ion exchanged water were mixed with wheat starch (WHEAT STARCH S, a trade name, produced by Shin-Shin Foods Co., Ltd.) and thoroughly dispersed to obtain a matting agent dispersion for a protective layer.

Preparation of Blended Coating Composition for Protective Layer

40 parts of the compound (K) (MEGAFAC F-120, 5% aqueous solution, a trade name, produced by Dainippon Ink and Chemicals, Inc.), 50 parts of sodium(4-nonylphenoxytrioxyethylene)butylsulfonate (2.0% aqueous solution, produced by Sankyo Chemical Co., Ltd.), 49.87 parts of the pigment dispersion for a protective layer, 8.3 parts of the matting agent dispersion for a protective layer and 48.7 parts of a zinc stearate dispersion (HYDRIN F115, 20.5% aqueous solution, a trade name, produced by Chukyo Yushi Co., Ltd.) were thoroughly mixed with 1,000 parts of the polyvinyl alcohol solution for a protective layer to thereby obtain a blended coating composition for a protective layer.

(7) Support having Undercoat Layer

Preparation of Undercoat Layer Composition

40 parts of enzyme-degradated gelatin (average molecular mass: 10,000, PAGI viscosity: 1.5 mPa·s (15 mP), PAGI jelly strength: 20 g) was added to 60 parts of ion exchanged water and dissolved with stirring at 40° C. to prepare a gelatin solution for an undercoat layer.

Separately, 8 parts of water-swellable synthetic mica (SOMASIF ME100, a trade name, produced by Co-op Chemical Co., Ltd., aspect ratio: 1,000) and 92 parts of water were mixed and then subjected to wet dispersion using a viscomill to obtain a mica dispersion having an average particle diameter of 2.0 μm. Water was added thereto to make a mica concentration of 5%, followed by thoroughly mixing, to prepare an intended mica dispersion.

120 parts of water and 556 parts of methanol were added to 100 parts of the 40% gelatin aqueous solution at 40° C., and after being thoroughly stirred and mixed, 208 parts of the 5% mica dispersion was added and sufficiently stirred and mixed. 9.8 parts of a 1.66% polyethylene oxide-containing surfactant was added thereto. While maintaining the liquid temperature at 35 to 40° C., 7.3 parts of an epoxy compound as a gelatin hardener was added to prepare a coating composition for an undercoat layer (5.7%).

Production of Support having Undercoat Layer

Wood pulp composed of 50 parts of LBPS and 50 parts of LBPK was beaten to a Canadian freeness of 300 ml, to which were added 0.5 part of epoxidized behenic acid amide, 1.0 part of anionic polyacrylamide, 1.0 part of aluminum sulfate, 0.1 part of polyamidepolyamine epichlorohydrin and 0.5 part of cationic polyacrylamide, all in terms of absolute dry mass with respect to the pulp. Body paper having a basis mass of 114 g/m² was made using a fourdrinier machine and then calendered to have a thickness of 100 μm.

After subjecting the body paper to a corona discharge treatment on both surfaces thereof, polyethylene was coated thereon to have a resin thickness of 36 μm using a melt extruder to form a resin matte surface (which was referred to as a back surface). On the opposite surface to the surface having the resin layer formed, there was coated polyethylene containing 10% of anatase-type titanium dioxide and a minute amount of an ultramarine blue pigment using a melt extruder to form a resin layer having a glossy surface (which was referred to as a front surface). After subjecting the polyethylene resin-coated surface on the back surface to a corona discharge treatment, aluminum oxide (ALUMINA SOL 100, a trade name, produced by Nissan Chemical Industries, Ltd.) and silicon dioxide (SNOWTEX O, a trade name, produced by Nissan Chemical Industries, Ltd.) (mass ratio: 1/2) were dispersed in water and the obtained dispersion was coated thereon, as an antistatic agent, to an amount after drying of 0.2 g/m². After subjecting the polyethylene resin-coated surface on the front surface to a corona discharge treatment, the undercoat composition was coated thereon to make a mica coated amount of 0.26 g/m² to obtain a support having an undercoat layer.

(8) Application of Coating Compositions for Heat-Sensitive Recording Layers

Seven layers were all together formed by simultaneously coating the coating composition (c) for a cyan color forming heat-sensitive recording layer, the coating composition for an intermediate layer, the coating composition (b) for a magenta color forming heat-sensitive recording layer, the coating composition for an intermediate layer, the coating composition (a) for a yellow color forming heat-sensitive recording layer, the coating composition for the light transmittance adjusting layer and the coating composition for a protective layer on the support having an undercoat layer in this order from the side of the support, and was dried under conditions of 30° C. and 30% RH and 40° C. and 30% RH, to thus obtain a multi-color heat-sensitive recording material of Example 1.

Coating was conducted in such a manner that the coating composition (a) for a heat-sensitive recording layer gave a coated amount of the diazo compound (A) of 0.078 g/m² in terms of solid content, the coating composition (b) for a heat-sensitive recording layer gave a coated amount of the diazo compound (D) of 0.206 g/m² in terms of solid content, and the coating composition (c) for a heat-sensitive recording layer gave a coated amount of the electron-donating dye precursor (H) of 0.355 g/m² in terms of solid content.

The coating composition for an intermediate layer produced a coated amount of 2.39 g/m² between the layers (a) and (b), and produced a coated amount of 3.34 g/m² between the layers (b) and (c), in terms of solid content. The coating composition for a light transmittance adjusting layer produced a coated amount of 2.35 g/m², and the coating composition for a protective layer produced a coated amount of 1.39 g/m², respectively in terms of solid content.

### Example 2

A multi-color heat-sensitive recording material of Example 2 was obtained in the same manner as in Example 1, except that the UV absorbent precursor A used in the microcapsule composition was changed to UV absorbent precursor B shown below.

UV Absorbent Precursor B

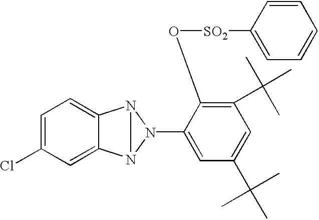

### Comparative Example 1

A multi-color heat-sensitive recording material of Comparative Example 1 was obtained in the same manner as in Example 1, except that the UV absorbent precursor A used in the microcapsule composition was changed to UV absorbent precursor C shown below.

UV Absorbent Precursor C

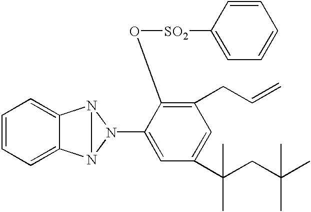

### Comparative Example 2

A multi-color heat-sensitive recording material of Comparative Example 2 was obtained in the same manner as in Example 1, except that the UV absorbent precursor A used in the microcapsule composition was changed to UV absorbent precursor D shown below.

UV Absorbent Precursor D

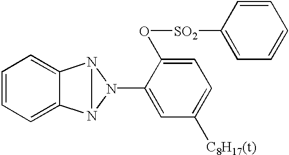

### Comparative Example 3

A multi-color heat-sensitive recording material of Comparative Example 3 was obtained in the same manner as in Example 1, except that the UV absorbent precursor A used in the microcapsule composition was changed to UV absorbent precursor E shown below.

UV Absorbent Precursor E

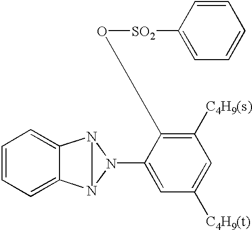

### Comparative Example 4

A multi-color heat-sensitive recording material of Comparative Example 4 was obtained in the same manner as in Example 1, except that the UV absorbent precursor A used in the microcapsule composition was changed to UV absorbent precursor F shown below.

UV Absorbent Precursor F

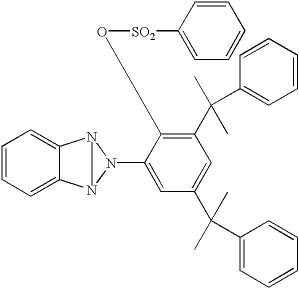

### Comparative Example 5

A multi-color heat-sensitive recording material of Comparative Example 5 was obtained in the same manner as in Example 1, except that the UV absorbent precursor A used in the microcapsule composition was changed to UV absorbent precursor G shown below.

UV Absorbent Precursor G

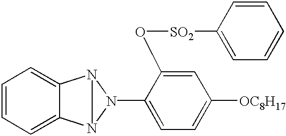

Measurement of Staining at Background Areas

The heat-sensitive recording materials thus produced were irradiated, at background areas, using a xenon light having an intensity of 390 W/m² for 228 hours. The resulting materials were evaluated for staining due to light irradiation using X-rite (produced by Nippon Lithograph, Inc.).

Table 1 shows the values of maximum absorption wavelength (λₘₐₓ) of UV absorbents, that were converted from the UV absorbent precursors, and the results of staining at background areas.

TABLE 1

| | | | Staining at |
|---|---|---|---|
| | | | Background |
| | | λₘₐₓ | Areas |
| Example 1 | UV absorbent precursor A | 348 | 0.259 |
| Example 2 | UV absorbent precursor B | 348 | 0.264 |
| Comparative | UV absorbent precursor C | 342 | 0.293 |
| Example 1 | | | |
| Comparative | UV absorbent precursor D | 340 | 0.284 |
| Example 2 | | | |
| Comparative | UV absorbent precursor E | 342 | 0.280 |
| Example 3 | | | |
| Comparative | UV absorbent precursor F | 342 | 0.280 |
| Example 4 | | | |
| Comparative | UV absorbent precursor G | 342 | 0.279 |
| Example 5 | | | |

As seen from the results shown in Table 1, it is revealed that the UV absorbent precursors represented by the general formula (1) (wherein Z is a halogen (chlorine) atom) exerted significant effects to suppress occurrence of staining due to light irradiation at background areas.

### Example 3

The same procedures were employed as in the items (1) to (4) in Example 1 to prepare respective solutions, except for the changes described below. Then, a coating composition for the light transmittance adjusting layer was prepared as described in the following item (5).

In the item (3), the following changes were made in the procedures. When preparing the coating composition for a cyan color forming heat-sensitive recording layer, 5.2 parts of an adduct of xylylene diisocyanate and trimethylolpropane and 6.8 parts of polymethylene polyphenyl isocyanate were mixed to obtain a mixed solution (XI). When preparing the electron-accepting compound dispersion (c), a dispersion was produced from 20 parts of 4,4′-(p-phenylenediisopropylidene)diphenol. When preparing the coating composition (c), the electron-donating dye precursor-containing microcapsule composition (c) was mixed with the electron-accepting compound dispersion (c) to make a mass ratio of the electron-accepting compound to the electron-donating dye precursor of 13/1, to thereby obtain a coating composition (c) for a cyan color forming heat-sensitive recording layer.

(5) Preparation of Coating Composition for Light Transmittance Adjusting Layer

Preparation of UV Absorbent Precursor Microcapsule Composition

47 parts in total of the following UV absorbent precursors X, Y, Z and W, 16 parts of 2,5-bis(t-octyl)hydroquinone, 6 parts of tricresyl phosphate, 19 parts of α-methylstyrene dimer (MSD-100, a trade name, produced by Mitsui Chemicals, Inc.) and 16 parts of calcium dodecylbenzenesulfonate (PIONIN A-41-C, 70% methanol solution, a trade name, produced Takemoto Oil & Fat Co., Ltd.) were thoroughly dissolved in 155 parts of ethyl acetate. 94 parts of an adduct of xylylene diisocyanate and trimethylolpropane (TAKENATE D110N, 75% ethyl acetate solution, a trade name, produced by Takeda Chemical Industries, Ltd.) as a capsule-wall material was added to the resultant mixed solution and thoroughly stirred to obtain a UV absorbent precursor mixture. The proportions of the UV absorbent precursors X, Y, Z and W were 15/15/35/35 in terms of mass ratios.

The UV absorbents converted from the UV absorbent precursors X, Y, Z and W, respectively, had the following maximum absorption wavelengths.

UV absorbent precursors X: 342 nm

UV absorbent precursors Y: 342 nm

UV absorbent precursors Z: 348 nm

UV absorbent precursors W: 350 nm

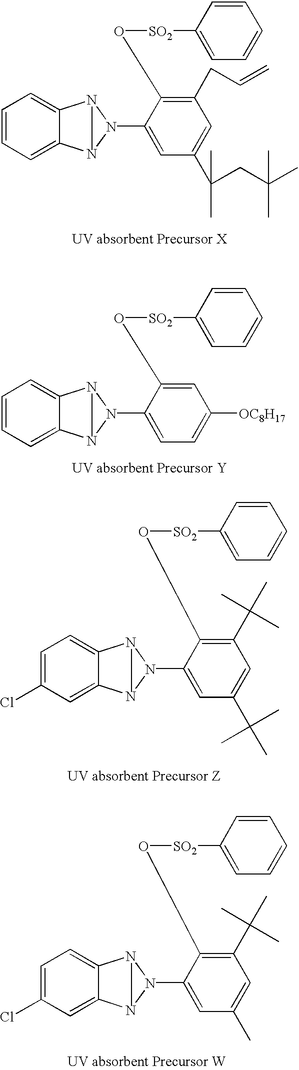

Separately, 17 parts of a 30% phosphoric acid aqueous solution and 1,038.5 parts of ion exchanged water were mixed with 99.5 parts of itaconic acid-modified polyvinyl alcohol (KL-318, a trade name, produced by Kuraray Co., Ltd.) to prepare a PVA aqueous solution for a UV absorbent precursor microcapsule composition.

The entire amount of the UV absorbent precursor mixture was added to the entire amount of the PVA aqueous solution for an UV absorbent precursor microcapsule composition and subjected to emulsification using a homogenizer (Nippon Seiki Co., Ltd.) at 40° C. 510 parts of ion exchanged water was added to the obtained emulsion, and after being homogenized, the mixture was subjected to an encapsulating reaction with stirring at 40° C. for 3 hours. Thereafter, 100 parts of an ion exchange resin (AMBERLITE MB-3, produced by Organo Corp.) was added thereto and further stirred for 1 hour. Then, the ion exchange resin was removed by filtration, and the concentration was adjusted to make a solids concentration of the capsule composition of 13% to thereby obtain a UV absorbent precursor microcapsule composition.

Preparation of Coating Composition for Light Transmittance Adjusting Layer

7.75 parts of a 4% sodium hydroxide aqueous solution and 73.39 parts of sodium 4-(4-nonylphenoxy)trioxyethylene)butylsulfonate (2.0% aqueous solution, produced by Sankyo Chemical Co., Ltd.) were mixed with 1,000 parts of the UV absorbent precursor microcapsule composition to obtain a coating composition for a light transmittance adjusting layer.

Subsequently, preparation of a coating composition for a protective layer, production of a support having an undercoat layer and application of respective coating compositions for the heat-sensitive recording layers were carried out employing the same procedures as described in the items (6), (7) and (8) in Example 1, except for the following changes.

In the item (6), 12.2 parts of colloidal silica was added to the pigment dispersion for the protective layer in the procedure. When producing the support having an undercoat, aluminum oxide and silicon dioxide were used in a mass ratio of 1/1.5 in the procedure in the item (7).

### Example 4

A multi-color heat-sensitive recording material of Example 4 was obtained in the same manner as in Example 3, except that the proportions of the UV absorbent precursors X, Y, Z and W used in the UV absorbent precursor microcapsule composition were changed to 25/25/25/25 in terms of mass ratios.

### Example 5

A multi-color heat-sensitive recording material of Example 5 was obtained in the same manner as in Example 3, except that the proportions of the UV absorbent precursors X, Y, Z and W used in the UV absorbent precursor microcapsule composition were changed to 35/35/15/15 in terms of mass ratios.

### Example 6

A multi-color heat-sensitive recording material of Example 6 was obtained in the same manner as in Example 3, except that the proportions of the UV absorbent precursors X, Y, Z and W used in the UV absorbent precursor microcapsule composition were changed to 0/50/25/25 in terms of mass ratios.

### Example 7

A multi-color heat-sensitive recording material of Example 7 was obtained in the same manner as in Example 3, except that the proportions of the UV absorbent precursors X, Y, Z and W used in the UV absorbent precursor microcapsule composition were changed to 50/0/25/25 in terms of mass ratios.

### Comparative Example 6

A multi-color heat-sensitive recording material of Comparative Example 6 was obtained in the same manner as in Example 3, except that the proportions of the UV absorbent precursors X, Y, Z and W used in the UV absorbent precursor microcapsule composition were changed to 0/0/100/0 in terms of mass ratios.

### Comparative Example 7

A multi-color heat-sensitive recording material of Comparative Example 7 was obtained in the same manner as in Example 3, except that the proportions of the UV absorbent precursors X, Y, Z and W used in the UV absorbent precursor microcapsule composition were changed to 0/0/0/100 in terms of mass ratios.

### Comparative Example 8

A multi-color heat-sensitive recording material of Comparative Example 8 was obtained in the same manner as in Example 3, except that the proportions of the UV absorbent precursors X, Y, Z and W used in the UV absorbent precursor microcapsule composition were changed to 100/0/0/0 in terms of mass ratios.

Measurement of Staining at Background Areas

The thus produced heat-sensitive recording materials were irradiated, at background areas, using a xenon light having an intensity of 390 W/m² for 228 hours. The resulting materials were evaluated for staining due to light irradiation using X-rite (produced by Nippon Lithograph, Inc.).

The solubility of the precursors in the coating compositions for the light transmittance adjusting layer as well as the deposition thereof in the same compositions were investigated, and the results thereof were summarized in Table 2 below, together with the results of staining at background areas.

Incidentally, the solubility was evaluated by two criteria, A: good solubility, B: poor solubility; and the deposition was evaluated by two criteria, A: no deposition, B: deposited.

TABLE 2

| | | | | | | | | Staining at |
|---|---|---|---|---|---|---|---|---|
| | Precursor X | Precursor Y | Precursor Z | Precursor W | (Z + W) | Solu- | Depo- | Background |
| | (342 nm) | (342 nm) | (348 nm) | (350 nm) | ratio | bility | sition | Areas |
| Example 3 | 15 | 15 | 35 | 35 | 70 | A | A | 0.211 |
| Example 4 | 25 | 25 | 25 | 25 | 50 | A | A | 0.215 |
| Example 5 | 35 | 35 | 15 | 15 | 30 | A | A | 0.222 |
| Example 6 | 0 | 50 | 25 | 25 | 50 | A | A | 0.212 |
| Example 7 | 50 | 0 | 25 | 25 | 50 | A | A | 0.220 |
| Comparative | 0 | 0 | 100 | 0 | 100 | B | B | |
| Example 6 | | | | | | | | |
| Comparative | 0 | 0 | 0 | 100 | 100 | B | B | |
| Example 7 | | | | | | | | |
| Comparative | 100 | 0 | 0 | 0 | 0 | A | A | 0.235 |
| Example 8 | | | | | | | | |

As seen from the results shown in Table 2, it is revealed that the heat-sensitive recording materials of Examples 3 to 7 exhibited good solubility of the UV absorbent precursor without separating out (depositing) it, and also suppressed occurrence of staining due to light irradiation at background areas.

In contrast, the heat-sensitive recording materials of Comparative Examples 6 and 7 exhibited poor solubility of the UV absorbent precursor to cause deposition thereof, thus failing in formation of the light transmittance adjusting layer. The heat-sensitive recording material of Comparative Example 8, although it exhibited good solubility of the precursor, produced insufficient results in staining at background areas.

As described above, the present invention provides a heat-sensitive recording material in which a layer containing a UV absorbent precursor can readily and stably be formed, and by which staining due to light irradiation at background areas can sufficiently be suppressed.

What is claimed is:

1. A heat-sensitive recording material comprising a support having succesively disposed thereon at least a heat-sensitive recording layer, a light transmittance adjusting layer and a protective layer, wherein the light transmittance adjusting layer contains a UV absorbent precursor represented by the following general formula (1)
General Formula (1) 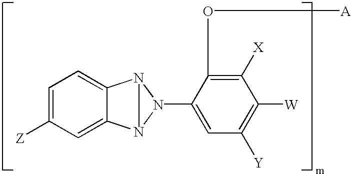
wherein:
m represents 1 or 2;
A represents —SO₂—R, —CO—R, —CO₂—R, —CONH—R, —POR¹R², —CH₂R³ or —SiR⁴R⁵R⁶ when m is 1, and A represents —SO₂R⁷SO₂—, —CO—, —COCO—, —COR⁷CO—, —SO₂— or —SO— when m is 2, in which R represents an alkyl group or an aryl group; R¹ and R² each represent an alkoxy group, an aryloxy group, an alkyl group or an aryl group; R³ represents a phenyl group substituted with at least one nitro group or at least one methoxy group; R⁴, R⁵ and R⁶ each represent an alkyl group or an aryl group; and R⁷represents an alkylene group or an arylene group;
W represents a hydrogen atom, an alkyl group, an aryl group or a halogen atom;
X and Y each represent a hydrogen atom, an alkyl group, an alkoxy group, aryl group or a halogen atom; and
Z represents a halogen atom.

2. The heat-sensitive recording material according to claim 1, wherein a UV absorbent, which is converted from the UV absorbent precursor represented by the general formula (1), has a maximum absorption wavelength of 348 nm or more.

3. The heat-sensitive recording material according to claim 1, wherein the UV absorbent precursor represented by the general formula (1) is encapsulated in microcapsules.

4. The heat-sensitive recording material according to claim 2, wherein the UV absorbent precursor represented by the general formula (1) is encapsulated in microcapsules.

5. The heat-sensitive recording material according to claim 1, wherein the heat-sensitive recording layer contains a diazonium salt compound and a coupler capable of reacting with the diazonium salt compound to form color.

6. The heat-sensitive recording material according to claim 2, wherein the heat-sensitive recording layer contains a diazonium salt compound and a coupler capable of reacting with the diazonium salt compound to form color.

7. The heat-sensitive recording material according to claim 1, wherein the heat-sensitive recording layer comprises a heat-sensitive recording layer A containing an electron-donating dye precursor and an electron-accepting compound, and a heat-sensitive recording layer B containing a diazonium salt compound and a coupler capable of reacting with the diazonium salt compound to form color, the heat-sensitive recording layer A and the heat-sensitive recording layer B constituting a laminated structure.

8. The heat-sensitive recording material according to claim 2, wherein the heat-sensitive recording layer comprises a heat-sensitive recording layer A containing an electron-donating dye precursor and an electron-accepting compound, and a heat-sensitive recording layer B containing a diazonium salt compound and a coupler capable of reacting with the diazonium salt compound to form color, the heat-sensitive recording layer A and the heat-sensitive recording layer B constituting a laminated structure.

9. The heat-sensitive recording material according to claim 1, wherein the heat-sensitive recording layer comprises a heat-sensitive recording layer A containing an electron-donating dye precursor and an electron-accepting compound, a heat-sensitive recording layer B containing a diazonium salt compound having a maximum absorption wavelength of 360±20 nm and a coupler capable of reacting with the diazonium salt compound to form color, and a heat-sensitive recording layer C containing another diazonium salt compound having a maximum absorption wavelength of 400±120 nm and another coupler capable of reacting with the another diazonium salt compound to form color, the heat-sensitive recording layer A, the heat-sensitive recording layer B, and the heat-sensitive recording layer C constituting a laminated structure.

10. The heat-sensitive recording material according to claim 2, wherein the heat-sensitive recording layer comprises a heat-sensitive recording layer A containing an electron-donating dye precursor and an electron-accepting compound, a heat-sensitive recording layer B containing a diazonium salt compound having a maximum absorption wavelength of 360±20 nm and a coupler capable of reacting with the diazonium salt compound to form color, and a heat-sensitive recording layer C containing another diazonium salt compound having a maximum absorption wavelength of 400±20 nm and another coupler capable of reacting with the another diazonium salt compound to form color, the heat-sensitive recording layer A, the heat-sensitive recording layer B, and the heat-sensitive recording layer C constituting a laminated structure.

11. A heat-sensitive recording material comprising a support having succesively disposed thereon at least a heat-sensitive recording layer, a light transmittance adjusting layer and a protective layer, wherein the light transmittance adjusting layer contains two or more kinds of UV absorbent precursors represented by the following general formula (1), and a UV absorbent converted from at least one of the UV absorbent precursors has a maximum absorption wavelength of 348 nm or more
General Formula (1) 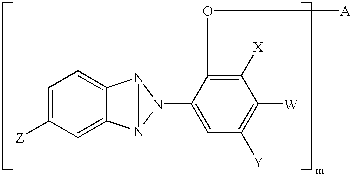
wherein:
m represents 1 or 2;
A represents —SO₂—R, —CO—R, —CO₂—R, —CONH—R, —POR¹R², —CH₂R³ or —SiR⁴R⁵R⁶ when m is 1, and A represents —SO₂R⁷SO₂—, —CO—, —COCO—, —COR⁷CO—, —SO₂— or —SO— when m is 2, in which R represents an alkyl group or an aryl group; R¹ and R² each represent an alkoxy group, an aryloxy group, an alkyl group or an aryl group; R³ represents a phenyl group substituted with at least one nitro group or at least one methoxy group; R⁴, R⁵ and R⁶ each represent an alkyl group or an aryl group; and R⁷ represents an alkylene group or an arylene group;
W represents a hydrogen atom, an alkyl group, an aryl group or a halogen atom;
X and Y each represent a hydrogen atom, an alkyl group, an alkoxy group, an aryl group or a halogen atom; and
Z represents a hydrogen atom, a halogen atom, an alkyl group or an alkoxy group.

12. The heat-sensitive recording material according to claim 11, wherein the at least one of the UV absorbent precursors, convertible to a UV absorbent having a maximum absorption wavelength of 348 nm or more, is contained in an amount of 25% by mass or more, relative to a total mass of the UV absorbent precursors.

13. The heat-sensitive recording material according to claim 11, wherein the UV absorbent precursors represented by the general formula (1) are encapsulated in microcapsules.

14. The heat-sensitive recording material according to claim 12, wherein the UV absorbent precursors represented by the general formula (1) are encapsulated in microcapsules.

15. The heat-sensitive recording material according to claim 11, wherein the heat-sensitive recording layer contains a diazonium salt compound and a coupler capable of reacting with the diazonium salt compound to form color.

16. The heat-sensitive recording material according to claim 12, wherein the heat-sensitive recording layer contains a diazonium salt compound and a coupler capable of reacting with the diazonium salt compound to form color.

17. The heat-sensitive recording material according to claim 11, wherein the heat-sensitive recording layer comprises a heat-sensitive recording layer A containing an electron-donating dye precursor and an electron-accepting compound, and a heat-sensitive recording layer B containing a diazonium salt compound and a coupler capable of reacting with the diazonium salt compound to form color, the heat-sensitive recording layer A and the heat-sensitive recording layer B constituting a laminated structure.

18. The heat-sensitive recording material according to claim 12, wherein the heat-sensitive recording layer comprises a heat-sensitive recording layer A containing an electron-donating dye precursor and an electron-accepting compound, and a heat-sensitive recording layer B containing a diazonium salt compound and a coupler capable of reacting with the diazonium salt compound to form color, the heat-sensitive recording layer A and the heat-sensitive recording layer B constituting a laminated structure.

19. The heat-sensitive recording material according to claim 11, wherein the heat-sensitive recording layer comprises a heat-sensitive recording layer A containing an electron-donating dye precursor and an electron-accepting compound, a heat-sensitive recording layer B containing a diazonium salt compound having a maximum absorption wavelength of 360±20 nm and a coupler capable of reacting with the diazonium salt compound to form color, and a heat-sensitive recording layer C containing another diazonium salt compound having a maximum absorption wavelength of 400±20 nm and another coupler capable of reacting with the another diazonium salt compound to form color, the heat-sensitive recording layer A, the heat-sensitive recording layer B, and the heat-sensitive recording layer C constituting a laminated structure.

20. The heat-sensitive recording material according to claim 12, wherein the heat-sensitive recording layer comprises a heat-sensitive recording layer A containing an electron-donating dye precursor and an electron-accepting compound, a heat-sensitive recording layer B containing a diazonium salt compound having a maximum absorption wavelength of 360±20 nm and a coupler capable of reacting with the diazonium salt compound to form color, and a heat-sensitive recording layer C containing another diazonium salt compound having a maximum absorption wavelength of 400±20 nm and another coupler capable of reacting with the another diazonium salt compound to form color, the heat-sensitive recording layer A, the heat-sensitive recording layer B, and the heat-sensitive recording layer C constituting a laminated structure.
